(19) United States
(12) Patent Application Publication
(10) Pub. No.: US 2025/0289030 A1
(43) Pub. Date: Sep. 18, 2025

(54) TRANSDUCER AND PREPARATION METHOD THEREFOR, SOUND GENERATION AND FINGERPRINT RECOGNITION STRUCTURES, AND DISPLAY DEVICE

(71) Applicant: BOE Technology Group Co., Ltd., Beijing (CN)

(72) Inventors: Zhao CUI, Beijing (CN); Zhonglan ZHAO, Beijing (CN); Feng ZHANG, Beijing (CN); Wenqu LIU, Beijing (CN); Zhijun LV, Beijing (CN); Liwen DONG, Beijing (CN); Detian MENG, Beijing (CN); Dongfei HOU, Beijing (CN); Yuqiao LI, Beijing (CN); Mengya SONG, Beijing (CN); Guoteng LI, Beijing (CN)

(21) Appl. No.: 18/859,570

(22) PCT Filed: Mar. 20, 2023
(86) PCT No.: PCT/CN2023/082570

§ 371 Date: Oct. 24, 2024

(51) Int. Cl. B06B 1/06; G06V 40/13; H04R 17/00

(52) U.S. Cl. CPC B06B 1/0611; G06V 40/1306; H04R 17/00; H04R 2499/15

(57) ABSTRACT

Provided in the present disclosure are an ultrasonic transducer and a preparation method therefor, a sound generation structure, a fingerprint recognition structure and a display device. The ultrasonic transducer comprises: a substrate (1); a cavity (3) located on the substrate (1); at least two vibrating diaphragm layers located on the substrate (1), wherein the at least two vibrating diaphragm layers are stacked in the thickness direction of the substrate (1) and are both located on the side of the cavity (3) away from the substrate (1), and orthographic projections of the at least two vibrating diaphragm layers overlap with an orthographic projection of the cavity (3) on the substrate (1); and a first electrode (61) and a second electrode (62), which are respectively located on opposite sides of each vibrating diaphragm layer in the thickness direction.

### CROSS-REFERENCE TO RELATED APPLICATION

The present application is a U.S. National Phase Entry of International Application No. PCT/CN2023/082570 having an international filing date of Mar. 20, 2023. Contents of the above-identified application are incorporated into the present application by reference.

### TECHNICAL FIELD

The present disclosure relates to, but is not limited to, the technical field of ultrasonic transducers, and in particular relates to an ultrasonic transducer and a preparation method therefor, a sound-producing structure, a fingerprint identification structure and a display device.

### BACKGROUND

Film piezoelectric ultrasonic transducers are attractive ideal candidates for many applications including a biometric sensor such as a fingerprint sensor, a gesture detection sensor, a microphone and speaker, an ultrasonic imaging sensor and a chemical sensor.

At present, a film piezoelectric ultrasonic transducer includes a base substrate and a plurality of sound-producing units arranged on the whole base substrate, and each sound-producing unit includes a cavity and a vibration film layer arranged on the cavity. A working mode of the sound-producing unit is to load the electrodes of the vibration film layer with electrical excitation, which makes the vibration film layer vibrate longitudinally and generate sound waves. However, a sound pressure of audible sound emitted by existing ultrasonic transducers is low.

### SUMMARY

The following is a summary of subject matters described herein in detail. This summary is not intended to limit the protection scope of the claims.

In one aspect, the present disclosure provides an ultrasonic transducer including:
a base substrate;
a cavity located on the base substrate;
at least two vibration film layers located on the base substrate, wherein the at least two vibration film layers are stacked in a thickness direction of the base substrate, the at least two vibration film layers are each located on a side of the cavity away from the base substrate, and orthographic projections of the at least two vibration film layers on the base substrate overlap with an orthographic projection of the cavity on the base substrate; and
a first electrode and a second electrode respectively located on opposite sides of each vibration film layer in the thickness direction;
wherein the first electrode or the second electrode is provided on a side of the at least two vibration film layers away from the base substrate.

In an exemplary implementation, the first electrode is provided on a side of the at least two vibration film layers close to the cavity.

In an exemplary implementation, orthographic projections of the at least two vibration film layers on the base substrate each overlap with orthographic projections of at least two cavities on the base substrate.

In an exemplary implementation, a first vibration film layer and a second vibration film layer sequentially stacked in a direction away from the base substrate are included. A first electrode layer is provided on a side of the first vibration film layer close to the cavity, and the first electrode layer includes a first electrode. A second electrode layer is provided between the first vibration film layer and the second vibration film layer, and the second electrode layer includes a second electrode. A third electrode layer is provided on a surface of the second vibration film layer away from the base substrate, and the third electrode layer includes a first electrode.

In an exemplary implementation, the second electrode of the second electrode layer serves as an electrode of the first vibration film layer and an electrode of the second vibration film layer.

In an exemplary implementation, a first vibration film layer, a second vibration film layer, and a third vibration film layer sequentially stacked in a direction away from the base substrate are included. A first electrode layer is provided on a side of the first vibration film layer close to the cavity, and the first electrode layer includes a first electrode. A second electrode layer is provided between the first vibration film layer and the second vibration film layer, and the second electrode layer includes a second electrode. A third electrode layer is provided between the second vibration film layer and the third vibration film layer, and the third electrode layer includes a first electrode. A fourth electrode layer is provided on a surface of the third vibration film layer away from the base substrate, and the fourth electrode layer includes a second electrode.

In an exemplary implementation, the second electrode of the second electrode layer serves as an electrode of the first vibration film layer and an electrode of the second vibration film layer, and the first electrode of the third electrode layer serves as an electrode of the second vibration film layer and an electrode of the third vibration film layer.

In an exemplary implementation, the at least two vibration film layers each include a vibration pattern, and an orthographic projection of the vibration pattern on the base substrate overlaps with an orthographic projection of one cavity on the base substrate.

In an exemplary implementation, a first vibration film layer and a second vibration film layer sequentially stacked in a direction away from the base substrate are included. The first vibration film layer includes at least one first vibration pattern, the second vibration film layer includes at least one second vibration pattern, and orthographic projections of the first vibration pattern, the second vibration pattern and the cavity on the base substrate overlap.

In an exemplary implementation, a first electrode is provided on a side of the first vibration pattern close to the cavity, a second electrode is provided between the first vibration pattern and the second vibration pattern, a first electrode is provided on a surface of the second vibration pattern away from the base substrate, and orthographic projections of the first vibration pattern, the second vibration pattern, the first electrode and the second electrode on the base substrate overlap.

In an exemplary implementation, a first vibration film layer, a second vibration film layer, and a third vibration film layer sequentially stacked in a direction away from the base substrate are included. The first vibration film layer includes a first vibration pattern, the second vibration film layer includes a second vibration pattern, the third vibration film layer includes a third vibration pattern, and orthographic projections of the first vibration pattern, the second vibration pattern, the third vibration pattern and the cavity on the base substrate overlap.

In an exemplary implementation, a first electrode is provided on a side of the first vibration pattern close to the cavity, a second electrode is provided between the first vibration pattern and the second vibration pattern, and a first electrode is provided between the second vibration pattern and the third vibration pattern. A second electrode is provided on a surface of the third vibration pattern away from the base substrate, and orthographic projections of the first vibration pattern, the second vibration pattern, the third vibration pattern, the first electrode and the second electrode on the base substrate overlap.

In an exemplary implementation, a material of the vibration film layer includes a polymer material.

In an exemplary embodiment, an etching hole is also included, and the etching hole is disposed in the same layer as the cavity and communicated with the cavity.

In an exemplary implementation, an etching flow channel is also included. The etching flow channel is disposed in the same layer as the cavity, one end of the etching flow channel is communicated with the etching hole, and the other end of the etching flow channel is communicated with the cavity.

In an exemplary implementation, one etching hole is communicated with one cavity.

In an exemplary implementation, a plurality of etching holes are communicated with one cavity.

In an exemplary implementation, two etching holes are located on opposite sides of one cavity, and the two etching holes are communicated with one cavity.

In an exemplary implementation, one etching hole is communicated with a plurality of cavities.

In an exemplary implementation, at least three cavities are arranged at intervals to form a column of cavities, two etching holes are located on a side of the column of cavities, the two etching holes are communicated with each other by a second etching flow channel, the two etching holes are respectively communicated with cavities at both ends of the column of cavities by first etching flow channels, and other cavities in the column of cavities are communicated with the second etching flow channel by first etching flow channels.

In an exemplary implementation, four cavities of the cavities are arranged in a rectangular manner, the four cavities are disposed around a perimeter of one etching hole, and the four cavities are all communicated with the one etching hole.

In an exemplary implementation, the first electrode is provided on a side of the at least two vibration film layers close to the cavity, and an orthographic projection of the etching hole on the base substrate does not overlap with an orthographic projection of the first electrode on the base substrate.

In an exemplary implementation, at least two cavities are included, and a distance between geometric centers of adjacent cavities is the same.

In an exemplary implementation, a support layer is also included, and the support layer is disposed in the same layer as the cavity.

In an exemplary implementation, the support layer includes an organic material.

In an exemplary implementation, an inorganic dielectric pattern is also included. The first electrode is disposed on a side of the at least two vibration film layers close to the cavity, the inorganic dielectric pattern is positioned between the support layer and the first electrode, and an edge region of the inorganic dielectric pattern is disposed on the support layer. An orthographic projection of a middle region of the inorganic dielectric pattern on the base substrate overlaps with an orthographic projection of the cavity on the base substrate, and the first electrode is disposed on a surface of the inorganic dielectric pattern away from the cavity.

In an exemplary implementation, an etching hole is also included, the etching hole is disposed in the same layer as the cavity and communicated with the cavity, and an orthographic projection of the inorganic dielectric pattern on the base substrate does not overlap with an orthographic projection of the etching hole on the base substrate.

In an exemplary implementation, at least two first electrodes and a first wire disposed in the same layer are included, the at least two first electrodes are arranged at intervals in a first direction to form a row of first electrodes, the first wire extends in the first direction, and adjacent first electrodes in the row of first electrodes are electrically connected to each other by the first wire.

In an exemplary implementation, at least two second electrodes and a second wire disposed in the same layer are included, the at least two second electrodes are arranged at intervals in a second direction to form a column of second electrodes, and the second wire extends in the second direction. Adjacent second electrodes in the column of second electrodes are electrically connected to each other by the second wire, orthographic projections of the first wire and the second wire on the base substrate do not overlap, and the first direction crosses the second direction.

In an exemplary implementation, orthographic projections of the first electrode and the second electrode on the base substrate both cover an orthographic projection of the cavity on the base substrate.

In an exemplary implementation, diameters of orthographic projections of the first electrode and the second electrode on the base substrate are both 1.2 to 2 times a diameter of an orthographic projection of the cavity on the base substrate.

In an exemplary implementation, a first additional electrode is also included. The first additional electrode is located on a side of a vibration film layer away from the second electrode. The first additional electrode and the first electrode are located on the same film layer, or the first additional electrode and the first electrode are located on different film layers. Orthographic projections of the first additional electrode and the first electrode on the base substrate do not overlap and the first additional electrode and the first electrode are insulated from each other. An orthographic projection of the first additional electrode on the base substrate overlaps with either of orthographic projections of the vibration film layer and the second electrode on the base substrate. A vibration direction of a vibration film layer between the first additional electrode and the second electrode is opposite to a vibration direction of a vibration film layer between the first electrode and the second electrode.

In an exemplary implementation, a first additional electrode and a second additional electrode are also included. The first additional electrode is located on a side of a vibration film layer away from the second electrode. The first additional electrode and the first electrode are located in the same film layer or the first additional electrode and the first electrode are located in different film layers. An orthographic projection of the first additional electrode on the base substrate does not overlap with an orthographic projection of the first electrode on the base substrate and the first additional electrode and the first electrode are insulated from each other. The second additional electrode is located on a side of the vibration film layer away from the first electrode. The second additional electrode and the second electrode are located in the same film layer or the second additional electrode and the second electrode are located in different film layers. An orthographic projection of the second additional electrode on the base substrate does not overlap with an orthographic projection of the second electrode on the base substrate and the second additional electrode and the second electrode are insulated from each other. Orthographic projections of the first additional electrode and the second additional electrode on the base substrate overlap and the orthographic projections of the first additional electrode and the second additional electrode on the base substrate overlap with an orthographic projection of the vibration film layer on the base substrate. A vibration direction of a vibration film layer between the first additional electrode and the second additional electrode is opposite to a vibration direction of a vibration film layer between the first electrode and the second electrode.

In an exemplary implementation, the orthographic projection of the first additional electrode on the base substrate is annular, and the orthographic projection of the first additional electrode on the base substrate surrounds an outer side of the orthographic projection of the first electrode on the base substrate.

In an exemplary implementation, the orthographic projection of the first additional electrode on the base substrate is annular and the orthographic projection of the first additional electrode on the base substrate surrounds an outer side of the orthographic projection of the first electrode on the base substrate; and/or, the orthographic projection of the second additional electrode on the base substrate is annular, and the orthographic projection of the second additional electrode on the base substrate surrounds an outer side of the orthographic projection of the second electrode on the base substrate.

In an exemplary implementation, a depth of the cavity is 5 microns to 20 microns.

In another aspect, the present disclosure also provides a fingerprint identification structure including the aforementioned ultrasonic transducer and a circuit layer disposed between the base substrate and the cavity of the ultrasonic transducer. The circuit layer includes at least one transistor electrically connected to a first electrode of the ultrasonic transducer.

In an exemplary implementation, a connection electrode is also included. At least a portion of the connection electrode is disposed in the same layer as the cavity. One end of the connection electrode is electrically connected to a first electrode of the ultrasonic transducer, and the other end of the connection electrode is electrically connected to the transistor of the circuit layer.

In yet another aspect, the present disclosure also provides a sound-producing structure including the aforementioned ultrasonic transducer.

In yet another aspect, the present disclosure also provides a display device, which includes the aforementioned fingerprint identification structure or the aforementioned sound-producing structure.

In an exemplary implementation, the base substrate of the ultrasonic transducer includes a display region and a bonding region located on at least one side of the display region. The display region is covered by a vibration film layer of the ultrasonic transducer. An orthographic projection of the vibration film layer of the ultrasonic transducer on the base substrate does not overlap with the bonding region.

In yet another aspect, the present disclosure also provides a preparation method for an ultrasonic transducer, including:
forming a cavity on the base substrate and forming a first electrode on the cavity; and
forming at least two vibration film layers, a first electrode and a second electrode on the first electrode.

The at least two vibration film layers are stacked in a thickness direction of the base substrate. Orthographic projections of the at least two vibration film layers on the base substrate overlap with an orthographic projection of the cavity on the base substrate. The first electrode and the second electrode are respectively located on opposite sides of each vibration film layer in the thickness direction. The first electrode or the second electrode is provided on a side of the at least two vibration film layers away from the base substrate.

In an exemplary implementation, the base substrate includes a cavity region and a non-cavity region. Forming a cavity on a base substrate and forming a first electrode on the cavity includes:
forming a metal film covering the cavity region and the non-cavity region on the base substrate;
etching and removing a portion of the metal film on the non-cavity region, and retaining the metal film on the cavity region and a portion of the metal film on the non-cavity region;
forming a support layer on the non-cavity region where the metal film is removed;
forming a first electrode on the support layer and the metal film on the cavity region, an orthographic projection of the first electrode on the base substrate overlapping with an orthographic projection of the metal film on the cavity region on the base substrate; and
by an etching process, removing a portion of the metal film on the non-cavity region to form an etching hole, and removing the metal film on the cavity region to form a cavity, the etching hole being communicated with the cavity.

In an exemplary implementation, forming a first electrode on the support layer and the metal film on the cavity region includes:
sequentially depositing an inorganic film and a first electrode film on the support layer and the cavity region; and
by a patterning process, forming the inorganic film into an inorganic dielectric pattern, and forming the first electrode film into a first electrode disposed on the inorganic dielectric pattern, wherein both an orthographic projection of the first electrode on the base substrate and an orthographic projection of the inorganic dielectric pattern on the base substrate do not overlap with an orthographic projection of the etching hole on the base substrate.

Other aspects may become clear after the accompanying drawings and the detailed description are read and understood.

### BRIEF DESCRIPTION OF DRAWINGS

Accompanying drawings are used for providing an understanding of technical solutions of the present application and form a part of the specification, are used for explaining the technical solutions of the present application together with embodiments of the present application, and do not constitute a limitation on the technical solutions of the present application.

FIG. 1 is a cross-sectional view of an ultrasonic transducer;

FIG. 2 is a schematic diagram of a structure of an ultrasonic transducer according to an embodiment of the present application;

FIG. 3 is a first cross-sectional view of an ultrasonic transducer according to an embodiment of the present application;

FIG. 4 is a first schematic diagram of an ultrasonic transducer of an embodiment of the present application after being electrified;

FIG. 5a is a first schematic diagram of a structure of first electrodes and second electrodes of an ultrasonic transducer according to an embodiment of the present application;

FIG. 5b is a second schematic diagram of a structure of first electrodes and second electrodes of an ultrasonic transducer according to an embodiment of the present application;

FIG. 6a is a first schematic diagram of a structure of a cavity of an ultrasonic transducer according to an embodiment of the present application;

FIG. 6b is a second schematic diagram of a structure of a cavity of an ultrasonic transducer according to an embodiment of the present application;

FIG. 6c is a third schematic diagram of a structure of a cavity of an ultrasonic transducer according to an embodiment of the present application;

FIG. 6d is a fourth schematic diagram of a structure of a cavity of an ultrasonic transducer according to an embodiment of the present application;

FIG. 7 is a second cross-sectional view of an ultrasonic transducer according to an embodiment of the present application;

FIG. 8 is a second schematic diagram of an ultrasonic transducer of an embodiment of the present application after being electrified;

FIG. 9 is a sound-producing principle diagram of an ultrasonic transducer according to an embodiment of the present application;

FIG. 10 is a third cross-sectional view of an ultrasonic transducer according to an embodiment of the present application;

FIG. 11 is a fourth cross-sectional view of an ultrasonic transducer according to an embodiment of the present application;

FIG. 12 is a cross-sectional view of a fingerprint identification structure according to an embodiment of the present application;

FIG. 13a is a schematic diagram after forming a metal film during the preparation of an ultrasonic transducer according to an embodiment of the present application;

FIG. 13b is a schematic diagram after removing a portion of a metal film during the preparation of an ultrasonic transducer according to an embodiment of the present application;

FIG. 13c is a schematic diagram after forming a support layer during the preparation of an ultrasonic transducer according to an embodiment of the present application;

FIG. 13d is a schematic diagram after forming a first electrode during the preparation of an ultrasonic transducer according to an embodiment of the present application;

FIG. 13e is a schematic diagram after forming a cavity during the preparation of an ultrasonic transducer according to an embodiment of the present application;

FIG. 14 is a fifth cross-sectional view of an ultrasonic transducer according to an embodiment of the present application;

FIG. 15 is a top view of a first additional electrode and a first electrode of an ultrasonic transducer according to an embodiment of the present application;

FIG. 16 is a sixth cross-sectional view of an ultrasonic transducer according to an embodiment of the present application; and

FIG. 17 is a top view of a second additional electrode and a second electrode of an ultrasonic transducer according to an embodiment of the present application.

### DETAILED DESCRIPTION

To make the objectives, technical solutions, and advantages of the present disclosure clearer, embodiments of the present disclosure will be described in detail below with reference to the drawings. It is to be noted that implementations may be implemented in multiple different forms. Those of ordinary skills in the art can easily understand such a fact that implementations and contents may be transformed into various forms without departing from the purpose and scope of the present disclosure. Therefore, the present disclosure should not be explained as being limited to the contents recorded in the following implementations only. The embodiments and features in the embodiments of the present disclosure may be randomly combined with each other if there is no conflict.

In the drawings, a size of each composition element, a thickness of a layer, or a region may be exaggerated sometimes for clarity. Therefore, an implementation of the present disclosure is not always limited to the size, and the shape and size of each component in the drawings do not reflect an actual scale. In addition, the drawings schematically illustrate ideal examples, and an implementation of the present disclosure is not limited to shapes, numerical values, or the like shown in the drawings.

Ordinal numerals “first”, “second”, “third” and the like in the specification are set not to form limits in numbers but only to avoid confusion between composition elements.

In the specification, for convenience, expressions “central”, “above”, “below”, “front”, “back”, “vertical”, “horizontal”, “top”, “bottom”, “inside”, “outside” and the like for indicating directional or positional relationships are used to illustrate positional relationships between the composition elements with reference to the drawing, which only are used to easily describe the specification and simplify the description and do not indicate or imply that involved devices or elements are required to have specific orientations and are structured and operated in the specific orientations, and thus should not be understood as limitations on the present disclosure. The positional relationships between the constituent elements may be changed as appropriate according to a direction in which each constituent element is described. Therefore, appropriate replacements based on situations are allowed, and the positional relationships are not limited to the expressions in the specification.

In the specification, unless otherwise specified and defined expressly, terms “mounting”, “mutual connection”, and “connection” should be understood in a broad sense. For example, it may be a fixed connection, or a detachable connection, or an integral connection; it may be a mechanical connection or an electrical connection; it may be a direct connection, or an indirect connection through middleware, or an internal communication between two elements. Those of ordinary skills in the art may understand specific meanings of the above terms in the present disclosure according to specific situations.

In the specification, a transistor refers to an element that at least includes three terminals, i.e., a gate electrode, a drain electrode, and a source electrode. The transistor has a channel region between the drain electrode (drain electrode terminal, drain region, or drain) and the source electrode (source electrode terminal, source region, or source), and a current can flow through the drain electrode, the channel region, and the source electrode. It is to be noted that in the specification, the channel region refers to a region through which a current mainly flows.

In the specification, a first electrode may be a drain electrode, and a second electrode may be a source electrode. Alternatively, the first electrode may be a source electrode, and the second electrode may be a drain electrode. In a case that transistors with opposite polarities are used, or in a case that a direction of a current changes during operation of a circuit, or the like, functions of the “source electrode” and the “drain electrode” are sometimes interchangeable. Therefore, the “source electrode” and the “drain electrode” are interchangeable in the specification.

In the specification, “electrical connection” includes connection of composition elements through an element with a certain electrical action. An “element with a certain electrical action” is not particularly limited as long as electrical signals may be sent and received between the connected constituent elements. Examples of the “element with a certain electrical action” not only include an electrode and a wiring, but also include a switching element such as a transistor, a resistor, an inductor, a capacitor, another element with various functions, etc.

In the specification, “parallel” refers to a state in which an angle formed by two straight lines is −10° or more and 10° or less, and thus also includes a state in which the angle is −5° or more and 5° or less. In addition, “perpendicular” refers to a state in which an angle formed by two straight lines is 80° or more and 100° or less, and thus also includes a state in which the angle is 85° or more and 95° or less.

In the specification, a “film” and a “layer” are interchangeable. For example, a “conductive layer” may be replaced with a “conductive film” sometimes. Similarly, an “insulation film” may be replaced with a “protective layer” sometimes.

In the present disclosure, “about” means that a boundary is not defined so strictly and numerical values within a range of process and measurement errors are allowed.

FIG. 1 is a cross-sectional view of an ultrasonic transducer. As shown in FIG. 1, the ultrasonic transducer includes a base substrate 1′, a flexible film layer 2′ disposed on the base substrate 1′, a first electrode 4′ disposed on the flexible film layer 2′, an inorganic dielectric layer 3′ disposed on the first electrode 4′, a vibration film layer 5′ disposed on the inorganic dielectric layer 3′, and a second electrode 6′ disposed on the vibration film layer 5′. The base substrate 1′ may be a glass base substrate. A cavity 8′ is provided in the base substrate l′ and the vibration film layer 5′ covers the cavity 8′. A protective layer 3′ is disposed between the first electrode 4′ and the vibration film layer 5′. The vibration film layer 5′ is located between the first electrode 4′ and the second electrode 6′, and the first electrode 4′ and the second electrode 6′ can apply an excitation voltage to the vibration film layer 5′ to cause the vibration film layer 5′ to vibrate. The cavity 8′ can provide a vibration space for the vibration film layer 5′ to increase a vibration amplitude of the vibration film layer 5′, thereby enhancing intensity of a sound wave emitted by the ultrasonic transducer.

The above ultrasonic transducer further includes a connection electrode 7′ disposed on the base substrate 1′, and the connection electrode 7′ may be formed by a silver paste preparation. The connection electrode 7′ is located on a peripheral side of a stacked structure formed by the first electrode 4′, the vibration film layer 5′ and the second electrode 6′, an end of the connection electrode 7′ is connected to the second electrode 6′, and the other end of the connection electrode 7′ can be connected to an external circuit. The connection electrode 7′ can transmit a driving signal provided by the external circuit to the second electrode 6′ so that an excitation voltage is generated between the second electrode 6′ and the first electrode 4′ to drive the vibration film layer 5′ to vibrate.

However, a resonant frequency of the above ultrasonic transducer is low, such as 40 KHz, resulting in a low sound pressure of the audible sound emitted by the ultrasonic transducer.

According to the research of the inventor of the present application, it is found that by increasing the excitation voltage, the sound pressure of audible sound emitted by the ultrasonic transducer can be increased. For example, when an excitation voltage is raised from 50 vpp to 100 vpp, a sound pressure level of the ultrasonic transducer can be increased by 6 levels. When the excitation voltage is raised from 50 vpp to 200 vpp, the sound pressure level of the ultrasonic transducer can be increased by 12 levels. When the excitation voltage is raised from 50 vpp to 400 vpp, the sound pressure level of ultrasonic transducer can be increased by 18 levels. When the excitation voltage is raised from 50 vpp to 800 vpp, the sound pressure level of the ultrasonic transducer can be increased by 24 levels.

According to the research of the inventor of the present application, it is found that by increasing a thickness of the vibration film layer, a sound pressure of the audible sound emitted by the ultrasonic transducer can be increased. Increasing the thickness of the vibration film layer requires increasing the corresponding excitation voltage to drive the vibration of the vibration film layer.

However, if an excitation voltage of the ultrasonic transducer is increased, the problem of the vibration film layer breakdown will occur, and the power consumption of the ultrasonic transducer will increase.

An embodiment of the application provides an ultrasonic transducer, including: a base substrate; a cavity located on the base substrate; at least two vibration film layers located on the base substrate, the at least two vibration film layers being stacked in a thickness direction of the base substrate, the at least two vibration film layers being each located on a side of the cavity away from the base substrate, and orthographic projections of the at least two vibration film layers on the base substrate overlapping with an orthographic projection of the cavity on the base substrate; and a first electrode and a second electrode respectively located on opposite sides of each vibration film layer in the thickness direction. A first electrode or a second electrode is provided on a side of the at least two vibration film layers away from the base substrate.

In an ultrasonic transducer of an embodiment of the present application, a first electrode and a second electrode are respectively provided on the opposite sides of each of the at least two vibration film layers, such that each vibration film layer can vibrate by an excitation voltage provided by the first electrode and the second electrode, thereby realizing directional sound production and increasing a sound pressure.

An ultrasonic transducer of an embodiment of the present application can reduce a thickness of each vibration film layer to reduce an excitation voltage. By stacking at least two vibration film layers, a thickness of the stacked layers of the vibration film layers in the ultrasonic transducer is ensured, thereby improving a sound pressure. The ultrasonic transducer can drive the stacked layers of the vibration film layers to vibrate by a low excitation voltage. For example, when a vibration film layer is 10 um, a maximum breakdown voltage of piezoelectric material of the vibration film layer is 200V, and a maximum excitation voltage of the vibration film layer is 200V. When the ultrasonic transducer includes two vibration film layers, each vibration film layer is 5 um, the maximum breakdown voltage of piezoelectric material of the vibration film layer is 100V, and the maximum excitation voltage of the vibration film layer can be 100V. Since each vibration film layer can be driven by an excitation voltage of 100V supplied by the corresponding first electrode and second electrode, the stacked layer formed by the two vibration film layers can vibrate under the excitation voltage of 100V, thus reaching a sound pressure when a thickness of the vibration film layer is 10 um.

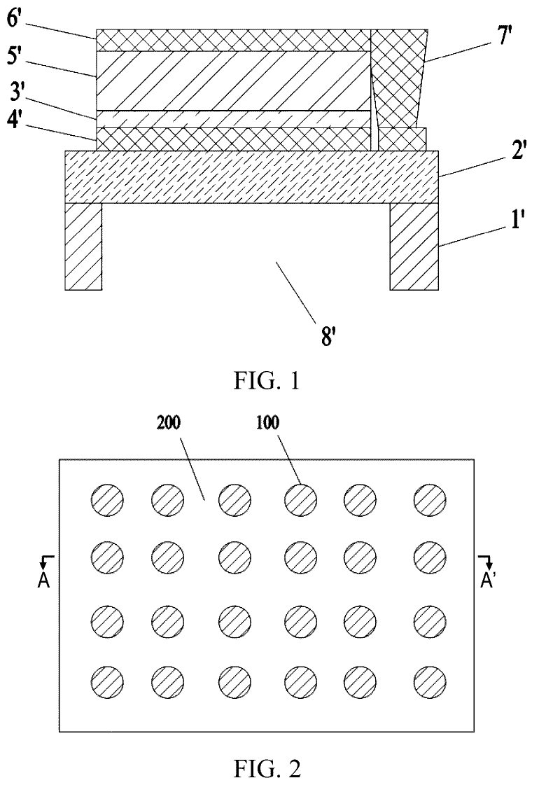

FIG. 2 is a schematic structural diagram of an ultrasonic transducer according to an embodiment of the present application. As shown in FIG. 2, in a direction parallel to a plane in which the ultrasonic transducer is located, the ultrasonic transducer includes a plurality of vibration regions 100 arranged at intervals and a non-vibration region 200 located outside the vibration region 100. A vibration region 100 is a region where vibration sounds, and a region defined by an outer contour of the vibration region 100 may be substantially equal to a region defined by an outer contour of a cavity in the ultrasonic transducer. The non-vibration region 200 is a region where vibration sound is not performed and the non-vibration region 200 may be a region other than a cavity in the ultrasonic transducer. A shape of a vibration region 100 may be the same as a shape of a cavity in the ultrasonic transducer, and the shape of the vibration region 100 may be a regular or irregular shape such as a circle, an ellipse, a rectangle, a square, a triangle, a diamond, a polygon. The non-vibration region 200 is provided around the periphery of the vibration regions 100.

In a direction perpendicular to a plane where the ultrasonic transducer is located, the vibration region 100 mainly includes a cavity provided on the base substrate and stacked layers formed by a plurality of vibration film layers. The stacked layers are located on a side of the cavity away from the base substrate, and the cavity can provide a vibration space for the stacked layers to increase a sound pressure. The stacked layers mainly include a plurality of vibration film layers, and a first electrode and a second electrode respectively located at opposite sides of each vibration film layer in a thickness direction, namely, a vibration film layer is disposed between each set of the first electrode and the second electrode. Each set of the first electrode and the second electrode can provide an excitation voltage to a vibration film layer located between the set of the first electrode and the second electrode such that the vibration film layer vibrates. A film layer of the stacked layers away from the base substrate is a first electrode or a second electrode, so as to ensure that the first electrode and the second electrode are disposed on the opposite sides of each vibration film layer.

In a direction perpendicular to a plane where the ultrasonic transducer is located, the non-vibration region 200 mainly includes a base substrate and a structural film layer disposed on the base substrate. The structural film layer may include an inorganic dielectric layer, a vibration film layer, a support layer, and the like. The cavity is not located in the non-vibration region 200.

Solutions of the embodiments will be described below through some examples.

The specific structure of an ultrasonic transducer is explained by taking an ultrasonic transducer of an embodiment of the present application as a sound-producing structure as an example.

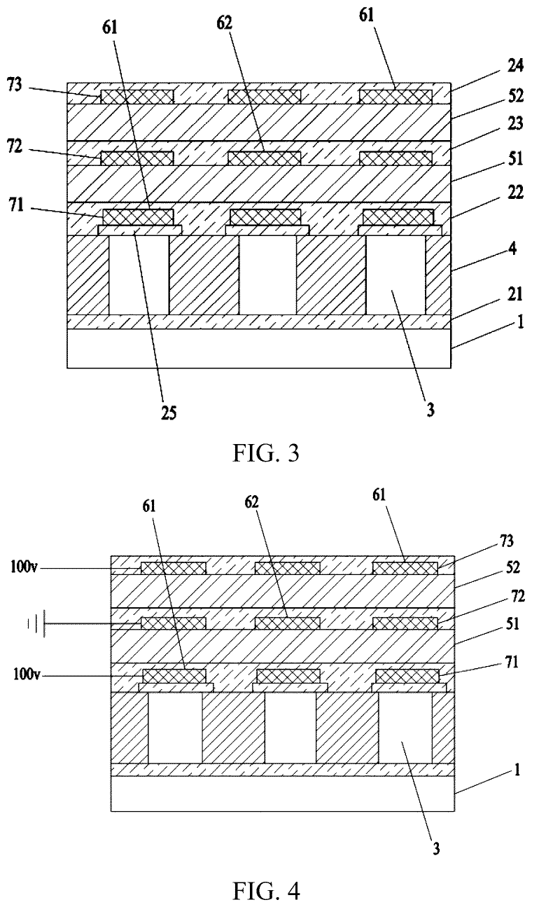

FIG. 3 is a first cross-sectional view of an ultrasonic transducer according to an embodiment of the present application. FIG. 3 is taken as an example, which is a cross-sectional view along an A-A′ direction of FIG. 2. As shown in FIG. 3, in a direction perpendicular to a plane where an ultrasonic transducer is located, the ultrasonic transducer of an embodiment of the present application includes a base substrate 1, a first inorganic dielectric layer 21 provided on the base substrate 1, at least one cavity 3 and a support layer 4 provided on the first inorganic dielectric layer 21, a first electrode layer 71 provided on a side of the cavity 3 and the support layer 4 away from the base substrate 1, a second inorganic dielectric layer 22 provided on the first electrode layer 71, a first vibration film layer 51 provided on the second inorganic dielectric layer 22, a second electrode layer 72 provided on the first vibration film layer 51, a third inorganic dielectric layer 23 provided on the second electrode layer 72, a second vibration film layer 52 provided on the third inorganic dielectric layer 23, a third electrode layer 73 provided on the second vibration film layer 52 and a fourth inorganic dielectric layer 24 provided on the third electrode layer 73.

In an exemplary embodiment, as shown in FIG. 3, the first electrode layer 71 may include at least one patterned first electrode 61, the second electrode layer 72 may include at least one patterned second electrode 62, and the third electrode layer 73 may include at least one patterned first electrode 61. Orthogonal projections of the cavity 3, the first electrode 61 of the first electrode layer 71, the first vibration film layer 51, the second electrode 62 of the second electrode layer 72, the second vibration film layer 52, and the first electrode 61 of the third electrode layer 73 on the base substrate 1 all overlap, and a size of the overlapping region is not limited here.

In an exemplary embodiment, as shown in FIG. 3, the first electrode 61 of the first electrode layer 71, the first vibration film layer 51, the second electrode 62 of the second electrode layer 72, the second vibration film layer 52, and the first electrode 61 of the third electrode layer 73 form a stacked layer. The cavity 3 may provide a vibration space for the stacked layer to raise a sound pressure.

An ultrasonic transducer according to an embodiment of the present application includes two vibration film layers (a first vibration film layer 51 and a second vibration film layer 52). Each vibration film layer is provided with a first electrode and a second electrode in a thickness direction, so that each vibration film layer can be driven by an excitation voltage provided by a set of the first electrode and the second electrode, thereby enabling the ultrasonic transducer to increase a sound pressure under a small excitation voltage.

FIG. 4 is a first schematic diagram of an ultrasonic transducer according to an embodiment of the present application after being electrified. FIG. 4 is taken as an example, which is a cross-sectional view along an A-A′ direction of FIG. 2. In an exemplary embodiment, as shown in FIG. 4, a first electrode 61 of a first electrode layer 71 and a second electrode 62 of a second electrode layer 72 may supply a first excitation voltage to a first vibration film layer 51 to cause the first vibration film layer 51 to vibrate. The second electrode 62 of the second electrode layer 72 and a first electrode 61 of a third electrode layer 73 may supply a second excitation voltage to the second vibration film layer 52 to cause a second vibration film layer 52 to vibrate.

In an exemplary embodiment, as shown in FIG. 4, the second electrode 62 of the second electrode layer 72 may serve as an electrode of the first vibration film layer 51 and the second vibration film layer 52, and may be combined with the first electrode 61 of the first electrode layer 71 and the first electrode 61 of the third electrode layer 73, respectively, to provide the first vibration film layer 51 and the second vibration film layer 52 with a first excitation voltage and a second excitation voltage. That is, the first vibration film layer 51 and the second vibration film layer 52 may share the second electrode 62 of the second electrode layer 72.

For example, as shown in FIG. 4, the first vibration film layer 51 and the second vibration film layer 52 are both made of a polyvinylidene fluoride (PVDF) piezoelectric material, a thickness of the first vibration film layer 51 and a thickness of the second vibration film layer 52 are both 5 microns, and a maximum excitation voltage of the first vibration film layer 51 and a maximum excitation voltage of the second vibration film layer 52 is 100V. The second electrode 62 of the second electrode layer 72 is grounded. The first electrode 61 of the first electrode layer 71 and the first electrode 61 of the third electrode layer 73 are respectively supplied with electric current, so that the first electrode 61 of the first electrode layer 71 and the second electrode 62 of the second electrode layer 72 can supply a first excitation voltage of 100v to the first vibration film layer 51 to drive the first vibration film layer 51 to vibrate, and so that the second electrode 62 of the second electrode layer 72 and the first electrode 61 of the third electrode layer 73 can supply a second excitation voltage of 100v to the second vibration film layer 52 to drive the second vibration film layer 52 to vibrate.

In an exemplary embodiment, both the first vibration film layer 51 and the second vibration film layer 52 of an embodiment of the present application may cover at least two cavities 3. Both the first vibration film layer 51 and the second vibration film layer 52 may be located in a vibration region and a non-vibration region of the ultrasonic transducer. Both the first vibration film layer 51 and the second vibration film layer 52 may be disposed over the entire surface without patterning. For example, when an ultrasonic transducer of an embodiment of the present application is applied to a display device as a sound-producing structure, the first vibration film layer 51 and the second vibration film layer 52 may cover the entire display region of a display substrate without covering a bonding region of the display substrate. That is, the first vibration film layer 51 and the second vibration film layer 52 are not provided on the bonding region of the display substrate.

In an exemplary embodiment, both the first vibration film layer 51 and the second vibration film layer 52 may be made of a piezoelectric material. A piezoelectric material can realize the mutual transformation of electrical signals and vibration signals. For example, both of the first vibration film layer 51 and the second vibration film layer 52 may be made of piezoelectric ceramics such as lead zirconate titanate piezoelectric ceramics (PZT), aluminum nitride (AlN) piezoelectric ceramics or zinc oxide (ZnO) piezoelectric ceramics. Alternatively, both the first vibration film layer 51 and the second vibration film layer 52 may be made of polyvinylidene fluoride (PVDF) copolymer.

In an exemplary embodiment, a material of the first vibration film layer 51 and a material of the second vibration film layer 52 may be the same, so that a structure can be simplified, a preparation process can be simplified, and the cost can be reduced.

In an exemplary embodiment, a thickness of the first vibration film layer 51 and a thickness of the second vibration film layer 52 may be determined according to the resonant frequency of the sound of the particular device.

In an exemplary embodiment, as shown in FIG. 3, the first electrode 61 of the first electrode layer 71 is disposed between the cavity 3 and the first vibration film layer 51, the second electrode 62 of the second electrode layer 72 is disposed between the first vibration film layer 51 and the second vibration film layer 52, and the first electrode 61 of the third electrode layer 73 is disposed on a side of the second vibration film layer 52 away from the base substrate.

In an exemplary embodiment, both the first electrode layer 71 and the third electrode layer 73 may include at least two patterned first electrodes 61 disposed at intervals. The number of first electrodes 61 of the first electrode layer 71 and the number of first electrodes 61 the third electrode layer 73 may be the same as the number of cavities 3, and the first electrodes 61 are provided in one-to-one correspondence with the cavities 3, i.e. orthographic projections of one of the first electrodes 61 and one of the cavities 3 on the base substrate overlap. At least two first electrodes 61 of the first electrode layer 71 are electrically connected and at least two first electrodes 61 of the third electrode layer 73 are electrically connected; and/or at least two first electrodes 61 of the first electrode layer 71 are disconnected from each other and at least two first electrodes 61 of the third electrode layer 73 are disconnected from each other.

In an exemplary embodiment, as shown in FIG. 3, an edge region of a first electrode 61 of the first electrode layer 71 may be disposed on the support layer 4, and an orthographic projection of the edge region of the first electrode 61 on the base substrate overlaps with an orthographic projection of the support layer 4 on the base substrate, so that the support layer 4 can support the first electrode 61. An orthographic projection of a middle region of a first electrode 61 of the first electrode layer 71 on the base substrate overlaps with an orthographic projection of the cavity 3 on the base substrate.

In an exemplary embodiment, as shown in FIG. 3, an orthographic projection of a first electrode 61 of the first electrode layer 71 on the base substrate may overlap with an orthographic projection of a first electrode 61 of the third electrode layer 73 on the base substrate. For example, an orthographic projection of a first electrode 61 of the first electrode layer 71 on the base substrate may completely overlap with an orthographic projection of a first electrode 61 of the third electrode layer 73 on the base substrate.

In an exemplary embodiment, the second electrode layer 72 may include at least two patterned second electrodes 62 disposed at intervals. The number of second electrodes 62 of the second electrode layer 72 may be the same as the number of cavities 3, and the second electrodes 62 are disposed in one-to-one correspondence with the cavities 3, i.e. an orthographic projection of one second electrode 62 on the base substrate overlaps with an orthographic projection of one cavity 3 on the base substrate. At least two second electrodes 62 are electrically connected; and/or, at least two second electrodes 62 are disconnected from each other.

In an exemplary embodiment, orthographic projections of a first electrode 61 of the first electrode layer 71 and a first electrode 61 of the third electrode layer 73 on the base substrate and an orthographic projection of a second electrode 62 of the second electrode layer 72 on the base substrate may each overlap with orthographic projections of the first vibration film layer 51 and the second vibration film layer 52 on the base substrate. For example, orthographic projections of at least two first electrodes 61 of the first electrode layer 71 and at least two first electrodes 61 of the third electrode layer 73 on the base substrate and orthographic projections of at least two second electrodes 62 of the second electrode layer 72 on the base substrate are each within an orthographic projection of one first vibration film layer 51 and an orthographic projection of one second vibration film layer 52 on the base substrate.

In an exemplary embodiment, materials of the first electrode 61 and the second electrode 62 may be flexible conductive materials, which may enable the first electrode 61 and the second electrode 62 to follow a vibration of a vibration film layer. For example, materials of the first electrode 61 and the second electrode 62 may include indium tin oxide (ITO), nano silver wires, graphene or flexible carbon nanotube conductive materials, etc.

In an exemplary embodiment, the first electrode 61 and the second electrode 62 may be prepared by different conductive materials. For example, a material of the first electrode 61 is indium tin oxide (ITO), and a material of the second electrode 62 is graphene.

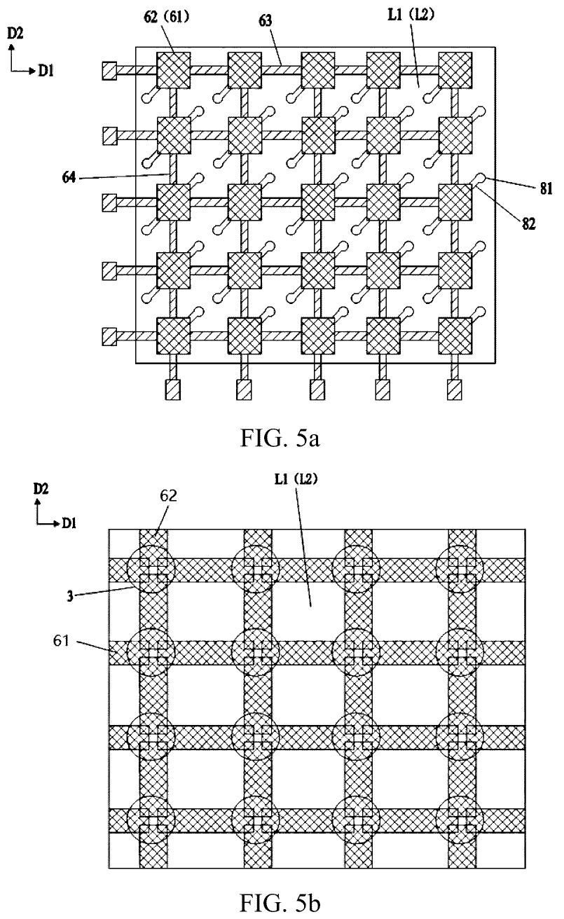

FIG. 5a is a first schematic diagram of a structure of first electrodes and second electrodes of an ultrasonic transducer according to an embodiment of the present application. In an exemplary embodiment, as shown in FIG. 5a, in a plane parallel to the base substrate, an orthographic projection of a first electrode 61 on the base substrate and an orthographic projection of a second electrode 62 on the base substrate can both be rectangular. An orthographic projection of a first electrode 61 on the base substrate and an orthographic projection of a second electrode 62 on the base substrate completely overlap, and the orthographic projection of the first electrode 61 on the base substrate and the orthographic projection of the second electrode 62 on the base substrate both cover an orthographic projection of a cavity on the base substrate.

In some embodiments, a diameter of an orthographic projection of a first electrode 61 on the base substrate and a diameter of an orthographic projection of a second electrode 62 on the base substrate are both 1.2 to 2 times a diameter of an orthographic projection of a cavity on the base substrate, so as to ensure that the orthographic projection of the first electrode 61 on the base substrate and the orthographic projection of the second electrode 62 on the base substrate both cover an orthographic projection of a cavity on the base substrate.

In some embodiments, the first and second electrodes may also take other shapes, for example, a shape of an orthographic projection of a first electrode on the base substrate and a shape of an orthographic projection of a second electrode on the base substrate may include a regular or irregular shape such as triangle, circle, ellipse, diamond, and polygon. The embodiments of the present application are not repeated here.

In an exemplary embodiment, as shown in FIG. 5a, both the first electrode layer 71 and the third electrode layer 73 may include at least two first electrodes 61 and a first wire 63 disposed in the same layer. At least two first electrodes 61 may be arranged at intervals in a first direction D1 to form a row of first electrodes. An orthographic projection of each first electrode 61 in the row of first electrodes on the base substrate completely overlaps with an orthographic projection of a cavity 3 on the base substrate. The first wire 63 extend in the first direction D1, and adjacent first electrodes 61 in the row of first electrodes are electrically connected to each other by the first wire 63, so that at least two first electrodes 61 in the row of first electrodes have the same voltage when a voltage is applied to the first electrode layer 71 or the third electrode layer 73, enabling amplitudes generated by vibration film layers to be the same. At least two rows of first electrodes are arranged at intervals in a second direction D2. First electrodes 61 in the at least two rows of first electrodes are disconnected from each other and are not connected by leads. The at least two rows of first electrodes have different voltages when a voltage can be applied to the at least two rows of first electrodes. The first direction D1 crosses the second direction D2, and both the first direction D1 and the second direction D2 are parallel to a plane where the base substrate is located. For example, the first direction D1 is perpendicular to the second direction D2.

In an exemplary embodiment, at least two first electrodes 61 and a first wire 63 are prepared in a single patterning process. Specifically, the at least two first electrodes 61 and the first wire 63 are simultaneously obtained by patterning a first electrode film.

In an exemplary embodiment, as shown in FIG. 5a, a first hollow region L1 is provided between at least two first electrodes 61 and between at least two rows of first electrodes. The first hollow region L1 is located in a non-vibration region of the ultrasonic transducer. A first wire 63 extends in the first hollow region L1, and an orthographic projection of the first wire 63 on the base substrate and an orthographic projection of the first hollow region L1 on the base substrate have a non-overlapping region, so as to avoid forming an excessive coupling capacitance in a non-vibration region under a large excitation voltage and thus affecting performance of a device.

In an exemplary embodiment, a first hollow region L1, a first wire 63, and a first electrode 61 are prepared in a single patterning process. Specifically, the first electrode 61, the first wire 63, and the first hollow region L1 are simultaneously obtained by patterning a first electrode film. A size and a contour shape of the first hollow region L1 are determined by the first electrode 61.

In an exemplary embodiment, as shown in FIG. 5a, a second electrode layer 72 may include at least two second electrodes 62 and a second wire 64 disposed in the same layer. The at least two second electrodes 62 may be arranged at intervals in a second direction D2 to form a column of second electrodes. An orthographic projection of each second electrode 62 in the column of second electrodes on the base substrate completely overlaps with an orthographic projection of one first electrode 61 on the base substrate and an orthographic projection of one cavity 3 on the base substrate. The second wire 64 extends in the second direction D2 to electrically connect adjacent second electrodes 62 in the column of second electrodes, so that at least two second electrodes 62 in the column of second electrodes have the same voltage when a voltage is applied to the second electrode layer 72, enabling frequencies of sound waves generated by a vibration film layer to be the same. At least two columns of second electrodes are arranged at intervals in a first direction D1. The at least two columns of second electrodes are disconnected from each other and have no lead connection. The at least two columns of second electrodes have different voltages when a voltage can be applied to the at least two columns of second electrodes.

In an exemplary embodiment, at least two second electrodes 62 and a second wire 64 are prepared in a single patterning process. Specifically, the at least two second electrodes 62 and the second wire 64 are simultaneously obtained by patterning a second electrode film.

In an exemplary embodiment, as shown in FIG. 5a, a second hollow region L2 is provided between at least two second electrodes 62 and between at least two columns of second electrodes. The second hollow region L2 is located in a non-vibration region of a ultrasonic transducer. An orthographic projection of the second hollow region L2 on the base substrate can completely overlap with an orthographic projection of the first hollow region L1 on the base substrate. A second wire 64 extends in the second hollow region L2, and an orthographic projection of the second wire 64 on the base substrate and an orthographic projection of the second hollow region L2 on the base substrate have a non-overlapping region, so as to avoid forming an excessive coupling capacitance in a non-vibration region under a large excitation voltage and thus affecting performance of a device.

In an exemplary embodiment, the second hollow region L2, the second wire 64, and the second electrodes 62 are prepared in a single patterning process. Specifically, the second electrodes 62, the second wire 64 and the second hollow region L2 are simultaneously obtained by patterning a second electrode film. A size and a contour shape of the second hollow region L2 are determined by the second electrodes 62.

FIG. 5b is a second schematic diagram of a structure of first electrodes and second electrodes of an ultrasonic transducer according to an embodiment of the present application. In an exemplary embodiment, as shown in FIG. 5b, both a first electrode 61 and a second electrode 62 may have a strip shape in a plane parallel to the base substrate. Orthographic projections of both ends of a first electrode 61 on the base substrate overlap with orthographic projections of the two cavities 3 on the base substrate, respectively, and an orthographic projection of a first electrode 61 on the base substrate and an orthographic projection of part of a cavity 3 on the base substrate do not overlap. Orthographic projections of both ends of a second electrode 62 on the base substrate overlap with orthographic projections of the two cavities 3 on the base substrate, respectively, and an orthographic projection of a second electrode 62 and an orthographic projection of part of a cavity 3 on the base substrate do not overlap. An orthographic projection of part of a first electrode 61 on the base substrate may overlap with an orthographic projection of part of a second electrode 62 on the base substrate.

In an exemplary embodiment, as shown in FIG. 5b, a first electrode layer 71 and a third electrode layer 73 may each include a plurality of first electrodes 61 arranged at intervals. A first electrode 61 has a strip shape extending in a first direction D1. At least two first electrodes 61 may be arranged at intervals in the first direction D1 to form a row of first electrodes in which adjacent first electrodes 61 are disconnected from each other. Orthographic projections of ends of adjacent first electrodes 61 in the row of first electrodes on the base substrate each overlap with an orthographic projection of a cavity 3 on the base substrate, and an orthographic projection of a spacing between adjacent first electrodes 61 in the row of first electrodes on the base substrate overlaps with an orthographic projection of the cavity 3 on the base substrate.

In an exemplary embodiment, as shown in FIG. 5b, at least two rows of first electrodes are arranged at intervals in a second direction D2. A first hollow region L1 is provided between adjacent rows of first electrodes. The first hollow region L1 is located in a non-vibration region of an ultrasonic transducer, so as to avoid forming excessive coupling capacitance in the non-vibration region under a large excitation voltage and thus affecting performance of a device.

In an exemplary embodiment, as shown in FIG. 5b, the second electrode layer 72 may include a plurality of second electrodes 62 disposed at intervals. A second electrode 62 has a strip shape extending in a second direction D2. At least two second electrodes 62 may be arranged at intervals in the second direction D2 to form a column of second electrodes. Adjacent second electrodes 62 in the column of second electrodes are disconnected from each other. Orthographic projections of ends of two adjacent second electrodes 62 in the column of second electrodes on the base substrate each overlap with an orthographic projection of a cavity 3 on the base substrate, and an orthographic projection of a spacing between adjacent second electrodes 62 in the column of second electrodes on the base substrate overlaps with an orthographic projection of the cavity 3 on the base substrate.

In an exemplary embodiment, as shown in FIG. 5b, at least two columns of second electrodes are arranged at intervals in a first direction D1. A second hollow region L2 is provided between adjacent columns of second electrodes. The second hollow region L2 is located in a non-vibration region of an ultrasonic transducer. An orthographic projection of the second hollow region L2 on the base substrate can completely overlap with an orthographic projection of the first hollow region L1 on the base substrate, so as to avoid forming excessive coupling capacitance in the non-vibration region under a large excitation voltage and thus affecting performance of the device.

In an exemplary embodiment, as shown in FIG. 3, an ultrasonic transducer of an embodiment of the present application further includes a fifth inorganic dielectric layer including inorganic dielectric patterns 25. An inorganic dielectric pattern 25 is positioned between a cavity 3 and a first electrode 61 of a first electrode layer. An edge region of the inorganic dielectric pattern 25 is disposed on the support layer 4. An orthographic projection of a middle region of the inorganic dielectric pattern 25 on the base substrate overlaps with an orthographic projection of the cavity 3 on the base substrate and an orthographic projection of the first electrode 61 of the first electrode layer on the base substrate. A surface of the inorganic dielectric pattern 25 away from the base substrate contacts with the first electrode 61 of the first electrode layer. The inorganic dielectric pattern 25 may ensure that during the formation of the cavity 3, a film layer (e.g. a first electrode) on the cavity 3 does not collapse causing damage to a device.

In an exemplary embodiment, as shown in FIG. 3, the fifth inorganic dielectric layer may include at least two inorganic dielectric patterns 25 arranged at intervals. The number of inorganic dielectric patterns 25 may be the same as the number of cavities 3, ensuring that one inorganic dielectric pattern 25 is provided on each of the cavities 3, that is, the inorganic dielectric patterns 25 may be disposed in one-to-one correspondence with the cavities 3. An orthographic projection of each inorganic dielectric pattern 25 on the base substrate overlaps with an orthographic projection of one of the cavities 3 on the base substrate.

In an exemplary embodiment, as shown in FIG. 3, a first inorganic dielectric layer 21, an inorganic dielectric pattern 25, a second inorganic dielectric layer 22, a third inorganic dielectric layer 23, and a fourth inorganic dielectric layer 24 may all be made of an inorganic material, for example, silicon nitride. Thicknesses of the first inorganic dielectric layer 21, the inorganic dielectric pattern 25, the second inorganic dielectric layer 22, the third inorganic dielectric layer 23, and the fourth inorganic dielectric layer 24 may each be 1000A to 2000A. The first inorganic dielectric layer 21 covers a surface of the base substrate 1 for protecting the base substrate 1. The second inorganic dielectric layer 22 may cover surfaces and sides of at least two first electrodes 61 for protecting the first electrodes 61. The third inorganic dielectric layer 23 may cover the surfaces and sides of at least two second electrodes 62 for protecting the second electrodes 62. The fourth inorganic dielectric layer 24 may cover the surfaces and sides of at least two first electrodes 61 for protecting the first electrodes 61.

In an exemplary embodiment, as shown in FIG. 3, a cavity 3 may be disposed in the same layer as a support layer 4. The support layer 4 is located in a non-vibration region of the ultrasonic transducer. The support layer 4 may be disposed around a perimeter of the cavity 3, and the side walls of the support layer 4 may serve as the side walls of the cavity 3. A depth of the cavity 3 in a thickness direction of the base substrate 1 is the same as a thickness of the support layer 3 in the thickness direction of the base substrate 1. The depth of the cavity 3 may be 5 microns to 20 microns. The depth of the cavity 3 is a length of the cavity 3 in a direction perpendicular to the base substrate.

In an exemplary implementation, a material of the support layer 4 may include an organic material, for example, an organic resin. The support layer 4 may be used to support an electrode and a vibration film layer.

In an exemplary embodiment, a ultrasonic transducer of an embodiment of the present application may include only one cavity 3. Alternatively, the ultrasonic transducer may include at least two cavities 3, and better sound effects may be achieved by the joint action of the at least two cavities 3.

In an exemplary embodiment, as shown in FIG. 2, the number of cavities 3 in the ultrasonic transducer may be the same as the number of first electrodes 61 of the first electrode layer, the number of first electrodes 61 of the third electrode layer, and the number of second electrodes 62. A first electrode 61 of a first electrode layer, a first vibration film layer 51, a second electrode 62 of a second electrode layer, a second vibration film layer 52 and a first electrode 61 of a third electrode layer are stacked on a side of each cavity 3 away from the base substrate, and an orthographic projection of each cavity 3 on the base substrate overlaps with each of orthographic projections of the first electrode 61 of the first electrode layer, the first vibration film layer 51, the second electrode 62 of the second electrode layer, the second vibration film layer 52, and the first electrode 61 of the third electrode layer on the base substrate.

In an exemplary embodiment, a size of a cavity 3 is determined according to a application scenario of an ultrasonic transducer and a resonant frequency of an ultrasonic wave it needs to emit. With different sizes of cavities 3, resonant frequencies of ultrasonic waves they needs to emit are different. A cavity 3 being circular is taken as an example, and a radius of the cavity 3 is determined by the following formula:

$${f}_{0} = 0.47 \frac{t}{{r}^{2}} \sqrt{\frac{E}{p ( 1 - {v}^{2} )}}$$

wherein f₀ is one class resonant frequency of an ultrasonic transducer, t is a thickness of a vibration film layer, r is the radius of the cavity 3, E is Young's modulus of the vibration film layer, p is a density of the vibration film layer, and v is a Poisson's ratio of the vibration film layer.

In an exemplary embodiment, a size of a first electrode 61 and a size of a second electrode 62 may be larger than a size of a cavity 3, so that an orthographic projection of an edge region of the first electrode 61 on the base substrate and an orthographic projection of an edge region of the second electrode 62 on the base substrate may each overlap with an orthographic projection of the support layer 4 on the base substrate, and a middle region of the first electrode 61 and a middle region of the second electrode 62 each completely overlap with the cavity 3. For example, taking an example that each of orthographic projections of a first electrode 61, a second electrode 62 and a cavity 3 on the base substrate is circular, a radius of the first electrode 61 and a radius of the second electrode 62 are slightly larger than a radius of the cavity 3. For example, the radius of the first electrode 61 and the radius of the second electrode 62 are both 1.2 times the radius of the cavity 3.

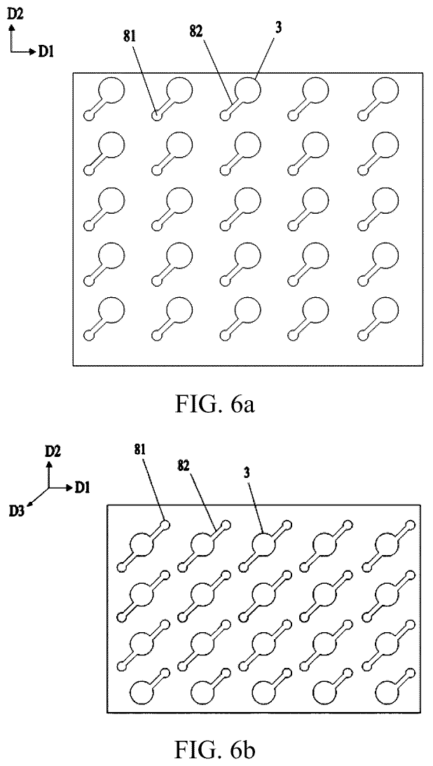

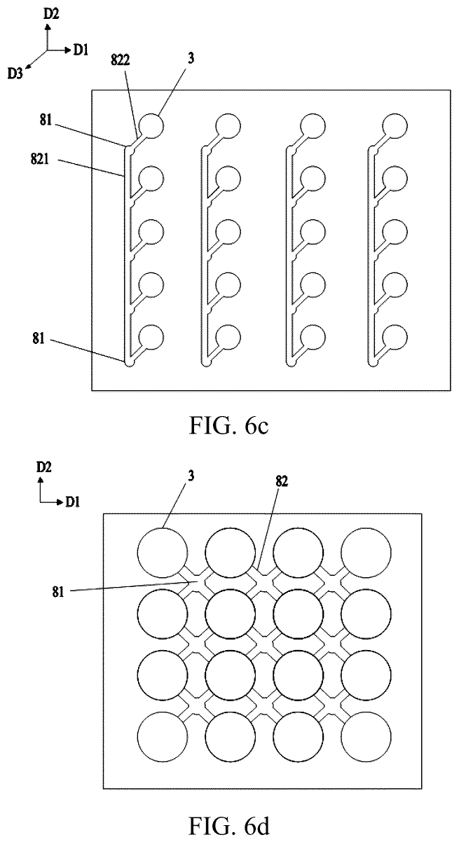

FIG. 6a is a first schematic diagram of a structure of cavities of an ultrasonic transducer according to an embodiment of the present application. In an exemplary embodiment, as shown in FIG. 6a, a cavity 3 may be circular in a plane parallel to a base substrate. At least two cavities 3 are arranged at intervals in a first direction D1 to form a row of cavities. At least two rows of cavities may be arranged at intervals in a second direction D2. A region between adjacent cavities 3 is a surface of the support layer 4 away from the base substrate.

In an exemplary embodiment, distances between geometric centers of adjacent cavities 3 may be equal so that a superimposed distribution of sound fields of sound waves emitted from each vibration region is more uniform, and so that the ultrasonic transducer has better signal stability and uniformity. A geometric center of a cavity 3 refers to a center of a region surrounded by an outer contour of the cavity 3. For example, the cavity 3 is circular, and a geometric center of the cavity 3 is a center of a circle. In some embodiments, distances between geometric centers of adjacent cavities 3 may also be unequal.

In some embodiments, a cavity 3 may also take other shapes. For example, a shape of the cavity 3 may include a regular or irregular shape such as a tringle, a rectangle, an ellipse, a diamond, a polygon. The embodiments of the present application are not repeated here.

In an exemplary embodiment, as shown in FIG. 6a, an ultrasonic transducer of the embodiment of the present application further includes etching holes 81 which may be disposed in the same layer as a cavity 3 and a support layer 4. At least one etching hole 81 is located on a peripheral side of the cavity 3 and communicates with the cavity 3. The etching hole 81 is configured as an inlet for etching liquid to enter a region where a cavity 3 is located during preparation of the cavity 3, so that the etching liquid can etch and remove a metal film located in the region where the cavity 3 is located to form the cavity 3.

In an exemplary embodiment, as shown in FIG. 6a, one etching hole 81 can communicate with one cavity 3. An area of an orthographic projection of the etching hole 81 on the base substrate is smaller than an area of an orthographic projection of the cavity 3 on the base substrate, so as to avoid the etching hole 81 occupying too much space.

In an exemplary embodiment, as shown in FIGS. 6a and 5a, etching holes 81 are located in a non-vibration region of an ultrasonic transducer. An orthographic projection of an etching hole 81 on the base substrate does not overlap with an orthographic projection of a first electrode 61 of a first electrode layer on the base substrate and an orthographic projection of an inorganic dielectric pattern 25 on the base substrate, so as to prevent the first electrode 61 and the inorganic dielectric pattern 25 from blocking the etching hole 81 so that the etching liquid cannot enter the etching hole 81 for etching. For example, orthographic projection of the etching holes 81 on the base substrate do not overlap with the orthographic projections of all the first electrodes 61, all the inorganic dielectric patterns 25 and all the second electrodes 62 on the base substrate, and the orthographic projections of the etching holes 81 on the base substrate do not overlap with orthographic projections of the first and second wires on the base substrate.

In an exemplary embodiment, an etching hole 81 may take a variety of shapes. For example, a shape of the etching hole 81 may include a regular or irregular shape such as a circle, a tringle, a rectangle, an ellipse, a diamond, a polygon. The embodiments of the present application are not repeated here.

In an exemplary embodiment, as shown in FIGS. 6a and 5a, an ultrasonic transducer of an embodiment of the present application further includes etching flow channels 82, which may be disposed in the same layer as an etching hole 81, a cavity 3 and a support layer 4. One end of an etching flow channel 82 communicates with the cavity 3, and the other end of the etching flow channel 82 communicates with the etching hole 81. The etching flow channel 82 is used to communicate the etching hole 81 with the cavity 3.

In an exemplary embodiment, as shown in FIGS. 6a and 5a, one end of an etching flow channel 82 communicates with an etching hole 81, and the other end of the etching flow channel 82 communicates with a cavity 3. At least part of an orthographic projection of the etching flow channel 82 on the base substrate does not overlap with the orthographic projections of the first electrode 61 and the second electrode 62 on the base substrate, so as to avoid the etching hole 81 interfering with a sound-producing effect of a vibration region where the cavity 3 is located.

In some embodiments, an orthographic projection of a first vibration film layer 51 on the base substrate and an orthographic projection of a second vibration film layer 52 on the base substrate may overlap with an orthographic projection of an etching hole 81 on the base substrate and an orthographic projection of an etching flow channel 82 on the base substrate. The first vibration film layer 51 and the second vibration film layer 52 do not vibrate in a non-vibration region. The etching hole 81 and the etching flow channel 82 do not provide a vibration space for the first vibration film layer 51 and the second vibration film layer 52.

FIG. 6b is second schematic diagram of a structure of cavities of an ultrasonic transducer according to an embodiment of the present application. In an exemplary embodiment, a plurality of etching holes communicate with one of the cavities. For example, as shown in FIGS. 6b and 5a, one cavity 3 can communicate with two etching holes 81, both of which are located in a non-vibration region of an ultrasonic transducer. Orthographic projection of the two etching holes 81 on the base substrate do not overlap with an orthographic projection of a first electrode 61 on the base substrate and an orthographic projection of a second electrode 62 on the base substrate. Two etching holes 81 may be located on opposite sides of the cavity 3 in a third direction D3, and respectively communicate with the cavity 3 by an etching flow channel 82. The third direction D3 crosses the first direction D1 and the second direction D2, and is parallel to a plane where the base substrate is located.

In an ultrasonic transducer according to an embodiment of the present application, two etching holes 81 communicate with a cavity 3, so that an etching liquid can simultaneously etch through the two etching holes 81 to form the cavity 3, thereby speeding up the preparation process of the cavity 3.

FIG. 6c is a third schematic diagram of a structure of cavities of an ultrasonic transducer according to an embodiment of the present application. In an exemplary embodiment, at least three cavities 3 are arranged at intervals in a second direction D2 to form a column of cavities. At least two etching holes 81 are all located on a side of the column of cavities in a first direction D1. At least two etching holes 81 are communicated by a first etching flow channel 821 extending in the second direction D2. A portion of the cavities in the column of cavities communicate with at least two etching holes 81 by second etching flow channels 822 extending in a third direction D3. A portion of the cavities in the column of cavities communicate with the first etching flow channel 821 by second etching flow channels 822 extending in the third direction D3, so that at least two cavities in the column of cavities can share at least two etching holes 81. For example, as shown in FIG. 6c, two etching holes 81 are located on a side of a column of cavities in a first direction D1. The two etching holes 81 communicate with each other by a first etching flow channel 821 extending in a second direction D2. The two etching holes 81 respectively communicate with cavities 3 located at both ends of the column of cavities in the second direction D2 by second etching flow channels 822 extending in a third direction D3, and the other cavities 3 in the column of cavities communicate with the first etching flow channel 821 by second etching flow channels 822, so that the cavities 3 in the column of cavities can share the two etching holes 81.

The ultrasonic transducer of the embodiment of the present application adopts the mode that the column of cavities shares the etching holes 81, so that the etching liquid can simultaneously etch to form cavities in the column of cavities by the etching holes 81, thereby simplifying a process and reducing a production cost.

FIG. 6d is a fourth schematic diagram of a structure of cavities of an ultrasonic transducer according to an embodiment of the present application. In an exemplary embodiment, at least two cavities 3 are disposed around a periphery of at least one etching hole 81 and both communicate with the at least one etching hole 81, so that the at least two cavities 3 can share the at least one etching hole 81. For example, as shown in FIG. 6d, four cavities 3 are arranged in a rectangular shape and are disposed around a perimeter of an etching hole 81 which is located at the center of a region enclosed by the four cavities 3. Each of the four cavities 3 communicates with the etching hole 81 by an etching flow channel 82, so that the four cavities 3 share one etching hole 81.

In an ultrasonic transducer of an embodiment of the present application, at least two cavities 3 share an etching hole 81, so that an etching liquid can etch at the same time by the etching hole 81 to form at least two cavities 3, thus simplifying a process and reducing a production cost.

In an exemplary embodiment, as shown in FIG. 6d, all the cavities 3 can communicate with each other by etching holes 81 and etching flow channels 82, so that an etching liquid can flow each other in all the cavities 3 and an etching speed of the cavities is accelerated.

An ultrasonic transducer of an embodiment of the present application may also include other numbers of vibration film layers. For example, the ultrasonic transducer may include three vibration film layers, four vibration film layers, five vibration film layers and the like, as long as each of vibration film layers is provided with a first electrode and a second electrode on opposite sides in a thickness direction, so as to ensure that each of vibration film layers can be provided with an excitation voltage by a set of the first electrode and the second electrode.

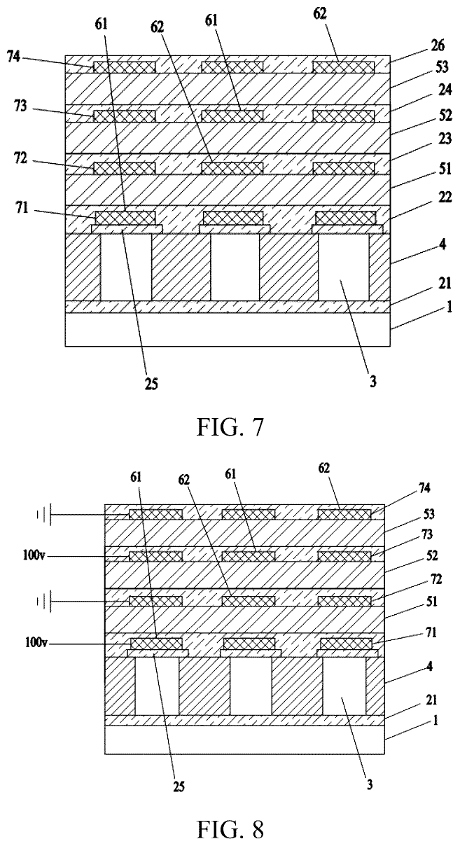

FIG. 7 is a second cross-sectional view of an ultrasonic transducer according to an embodiment of the present application. FIG. 7 is taken as an example, which is a cross-sectional view along an A-A′ direction of FIG. 2. In an exemplary implementation, as shown in FIG. 7, in a direction perpendicular to a plane where an ultrasonic transducer is located, the ultrasonic transducer of an embodiment of the present application includes a base substrate 1, a first inorganic dielectric layer 21 provided on the base substrate 1, at least one cavity 3 and a support layer 4 provided on the first inorganic dielectric layer 21, an inorganic dielectric pattern 25 provided on the cavity 3 and the support layer 4, a first electrode layer 71 provided on the inorganic dielectric pattern 25, a second inorganic dielectric layer 22 provided on the first electrode layer 71, a first vibration film layer 51 provided on the second inorganic dielectric layer 22, a second electrode layer 72 provided on the first vibration film layer 51, a third inorganic dielectric layer 23 provided on the second electrode layer, a second vibration film layer 52 provided on the third inorganic dielectric layer 23, a third electrode layer 73 provided on the second vibration film layer 52, a fourth inorganic dielectric layer 24 provided on the third electrode layer 73, a third vibration film layer 53 provided on the fourth inorganic dielectric layer 24, a fourth electrode layer 74 provided on the third vibration film layer 53, and a sixth inorganic dielectric layer 26 provided on the fourth electrode layer 74.

In an exemplary embodiment, as shown in FIG. 7, a first electrode layer 71 may include at least one patterned first electrode 61. A second electrode layer 72 may include at least one patterned second electrode 62. A third electrode layer 73 may include at least one patterned first electrode 61. A fourth electrode layer 74 may include at least one patterned second electrode 62. Orthogonal projections of the cavity 3, the first electrode 61 of the first electrode layer 71, the first vibration film layer 51, the second electrode 62 of the second electrode layer 72, the second vibration film layer 52, the first electrode 61 of the third electrode layer 73, the third vibration film layer 53, and the second electrode 62 of the fourth electrode layer 74 on the base substrate 1 overlap, and a size of an overlapping region is not limited here. A stacked layer of vibration film layers is formed by the first electrode 61 of the first electrode layer 71, the first vibration film layer 51, the second electrode 62 of the second electrode layer 72, the second vibration film layer 52, the first electrode 61 of the third electrode layer 73, the third vibration film layer 53, and the second electrode 62 of the fourth electrode layer 74. The cavity 3 can provide a space for the stacked layer of the vibration film layers to vibrate and raise a sound pressure.

An ultrasonic transducer of an embodiment of the present application includes three vibration film layers (a first vibration film layer 51, a second vibration film layer 52 and a third vibration film layer 53). Each of the vibration film layers is provided with a first electrode and a second electrode in a thickness direction, so that each of the vibration film layers can be driven by an excitation voltage provided by a set of the first electrode and the second electrode, thereby increasing a sound pressure.

FIG. 8 is a second schematic diagram of an ultrasonic transducer according to an embodiment of the present application after being electrified. FIG. 3 is taken as an example, which is a cross-sectional view along an A-A′ direction of FIG. 2. In an exemplary embodiment, as shown in FIG. 8, first electrodes 61 of a first electrode layer 71 and second electrodes 62 of a second electrode layer 72 may supply a first excitation voltage to a first vibration film layer 51 to cause the first vibration film layer 51 to vibrate. The second electrodes 62 of a second electrode layer 72 and first electrodes 61 of a third electrode layer 73 can supply a second excitation voltage to a second vibration film layer 52 to cause the second vibration film layer 52 to vibrate. The first electrodes 61 of the third electrode layer 73 and second electrodes 62 of a fourth electrode layer 74 may supply a third excitation voltage to a third vibration film layer 53 to cause the third vibration film layer 53 to vibrate.

In an exemplary embodiment, as shown in FIG. 8, a second electrode 62 of a second electrode layer 72 may simultaneously serve as an electrode of a first vibration film layer 51 and an electrode of a second vibration film layer 52, and may be combined with a first electrode 61 of the first electrode layer 71 and a first electrode 61 of the third electrode layer 73, respectively, to supply a first excitation voltage and a second excitation voltage to the first vibration film layer 51 and the second vibration film layer 52. The first electrode 61 of the third electrode layer 73 may simultaneously serve as an electrode of a second vibration film layer 52 and an electrode of a third vibration film layer 53, and may be combined with the second electrode 62 of the second electrode layer 72 and a second electrode 62 of a fourth electrode layer 74, respectively, to supply a second excitation voltage and a third excitation voltage to the second vibration film layer 52 and the third vibration film layer 53. That is, the first vibration film layer 51 and the second vibration film layer 52 may share the second electrode 62 of the second electrode layer 72, and the second vibration film layer 52 and the third vibration film layer 53 may share the first electrode 61 of the third electrode layer 73.

For example, as shown in FIG. 8, a first vibration film layer 51, a second vibration film layer 52, and a third vibration film layer 53 are all made of polyvinylidene fluoride (PVDF) material. Thicknesses of the first vibration film layer 51, the second vibration film layer 52, and the third vibration film layer 53 are all 5 microns. Maximum excitation voltages of the first vibration film layer 51, the second vibration film layer 52, and the third vibration film layer 53 are all 100v. Second electrodes 62 of a second electrode layer 72 and second electrodes 62 of a fourth electrode layer 74 are grounded, and electric currents are respectively applied to first electrodes 61 of a first electrode layer 71 and first electrodes 61 of a third electrode layer 73, such that the first electrodes 61 of the first electrode layer 71 and the second electrodes 62 of the second electrode layer 72 may supply a first excitation voltage of 100v to the first vibration film layer 51, the second electrodes 62 of the second electrode layer 72 and the first electrodes 61 of the third electrode layer 73 may supply a second excitation voltage of 100v to the second vibration film layer 52, and the first electrodes 61 of the third electrode layer 73 and the second electrodes 62 of the fourth electrode layer 74 may supply a third excitation voltage of 100v to the third vibration film layer 53.

In an exemplary embodiment, a first vibration film layer 51, a second vibration film layer 52, and a third vibration film layer 53 according to an embodiment of the present application may all be located in a vibration region and a non-vibration region of an ultrasonic transducer. The first vibration film layer 51, the second vibration film layer 52, and the third vibration film layer 53 may all be disposed over the entire surface without patterning. The first vibration film layer 51, the second vibration film layer 52, and the third vibration film layer 53 may all cover at least two cavities 3. When an ultrasonic transducer according to the embodiment of the present application is applied to a display device as a sound-producing structure, a first vibration film layer 51, a second vibration film layer 52, and a third vibration film layer 53 can each cover the entire display region of a display substrate without covering a bonding region of the display substrate. That is, the first vibration film layer 51, the second vibration film layer 52, and the third vibration film layer 53 are not provided on the bonding region of the display substrate.

An embodiment of the present application also provides a sound-producing structure, which may include the ultrasonic transducer as described in any one of the embodiments (e.g. the ultrasonic transducer shown in FIG. 3 or FIG. 7). The sound-producing structure may be applied to a display device in combination with a display substrate. For example, a sound-producing structure according to an embodiment of the present application may be provided on a light emitting surface of a display substrate, or the sound-producing structure according to the embodiment of the present application may be provided on a backlight surface of a display substrate.

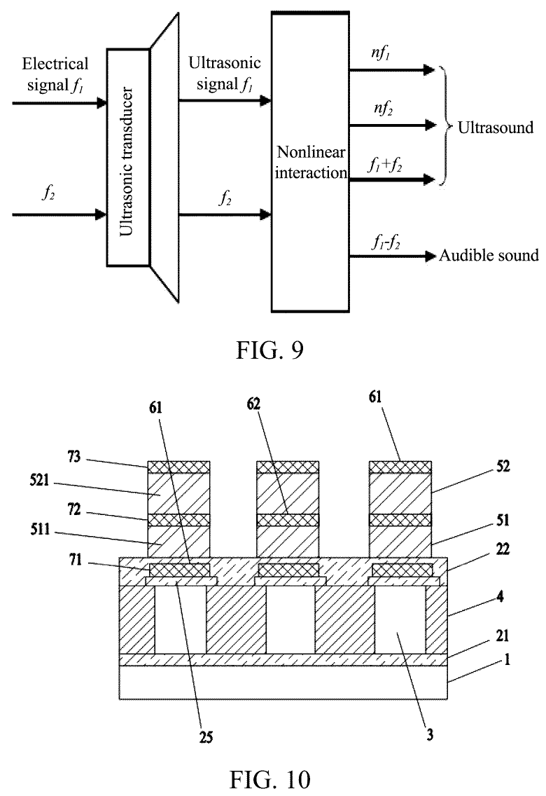

FIG. 9 is a sound-producing principle diagram of an ultrasonic transducer according to an embodiment of the present application. A sound-producing principle of an ultrasonic transducer according to an embodiment of the present application is as follows.

When two columns of plane waves propagate in an inhomogeneous media, they will interact and produce difference frequency, sum frequency and second harmonic. As shown in FIG. 9, two electrical signals with frequencies f1 and f2, respectively, are applied to an ultrasonic transducer to make it generate mechanical vibration, such that two columns of ultrasonic waves with frequencies f1 and f2, respectively, are generated in the air. During the propagation process, the two columns of waves are affected by a nonlinear interaction of air, such that multiple acoustic waves with frequencies f1, f2, f1+f2, f1-f2, 2f1 and 2f2 and the like are generated. Because an attenuation coefficient of air sound is proportional to the square of frequency, with the increase of propagation distance, ultrasonic signals with higher frequencies f1, f2, f1+f2, 2f1 and 2f2 are quickly absorbed by air and attenuated, and the remaining difference frequency signal with lower frequency f1-f2 continue to propagate in the air. When f1 and f2 are reasonably selected, the difference frequency signal f1-f2 can be within an audible frequency range. Therefore, the high directivity of ultrasound and its nonlinear propagation effect can be used to produce audible sound with high directivity.

FIG. 10 is a third cross-sectional view of an ultrasonic transducer according to an embodiment of the present application. In an exemplary implementation, as shown in FIG. 10, in a direction perpendicular to a plane where an ultrasonic transducer is located, the ultrasonic transducer of an embodiment of the present application includes a base substrate 1, a first inorganic dielectric layer 21 provided on the base substrate 1, at least one cavity 3 and a support layer 4 provided on the first inorganic dielectric layer 21, an inorganic dielectric pattern 25 provided on the cavity 3 and the support layer 4, a first electrode layer 71 provided on the inorganic dielectric pattern 25, a second inorganic dielectric layer 22 provided on the first electrode layer 71, a first vibration film layer 51 provided on the second inorganic dielectric layer 22, a second electrode layer 72 provided on the first vibration film layer 51, a second vibration film layer 52 provided on the second electrode layer and a third electrode layer 73 provided on the second vibration film layer 52.

In an exemplary embodiment, as shown in FIG. 10, a first electrode layer 71 may include at least one patterned first electrode 61, a second electrode layer 72 may include at least one patterned second electrode 62, and a third electrode layer 73 may include at least one patterned first electrode 61.

In an exemplary implementation, as shown in FIG. 10, a first vibration film layer 51 may include at least one patterned first vibration pattern 511, and a second vibration film layer 52 may include at least one patterned second vibration pattern 521. The first vibration pattern 511 and the second vibration pattern 521 are both located in a vibration region of the ultrasonic transducer. Orthographic projections of the first vibration pattern 511, the second vibration pattern 521 and a cavity 3 on the base substrate 1 overlap. For example, the orthographic projection of the cavity 3 on the base substrate 1 is located in the orthographic projection of the first vibration pattern 511 on the base substrate 1 and the orthographic projection of the second vibration pattern 521 on the base substrate 1. A first electrode 61 of the first electrode layer 71 and a second electrode 62 of the second electrode layer 72 are provided on opposite sides of the first vibration pattern 511 in a thickness direction, respectively. An orthographic projection of the first vibration pattern 511 on the base substrate 1 overlaps with orthographic projections of the first electrode 61 of the first electrode layer 71 and the second electrode 62 of the second electrode layer 72 on the base substrate 1. The first vibration pattern 511 may be vibrated by a first excitation voltage supplied by the first electrode 61 of the first electrode layer 71 and the second electrode 62 of the second electrode layer 72. A second electrode 62 of the second electrode layer 72 and a first electrode 61 of the third electrode layer 73 are provided on opposite sides of the second vibration pattern 521 in a thickness direction, respectively. An orthographic projection of the first vibration pattern 511 on the base substrate 1 overlaps with orthographic projections of the second electrode 62 of the second electrode layer 72 and the first electrode 61 of the third electrode layer 73 on the base substrate 1. The first vibration pattern 511 may be vibrated by a second excitation voltage supplied by the second electrode 62 of the second electrode layer 72 and the first electrode 61 of the third electrode layer 73.

In an exemplary implementation, as shown in FIG. 10, a first vibration film layer 51 may include at least two first vibration patterns 511. The number of the first vibration patterns 511 of the first vibration film layer 51 may be the same as the number of cavities 3. A third hollow region is provided between the at least two first vibration patterns 511. The third hollow region is located in a non-vibration region of an ultrasonic transducer. An orthographic projection of the third hollow region on the base substrate does not overlap with an orthographic projection of a cavity on the base substrate. A plurality of first vibration patterns 511 and third hollow regions may be formed by patterning a first vibration film.

In an exemplary implementation, as shown in FIG. 10, a second vibration film layer 52 may include at least two second vibration patterns 521. The number of second vibration patterns 521 of the second vibration film layer 52 may be the same as the number of cavities 3. A fourth hollow region is provided between the at least two second vibration patterns 521. The fourth hollow region is located in a non-vibration region of an ultrasonic transducer. An orthographic projection of the fourth hollow region on the base substrate does not overlap with an orthographic projection of a cavity on the base substrate. A plurality of second vibration patterns 521 and fourth hollow regions may be formed by patterning a second vibration film.

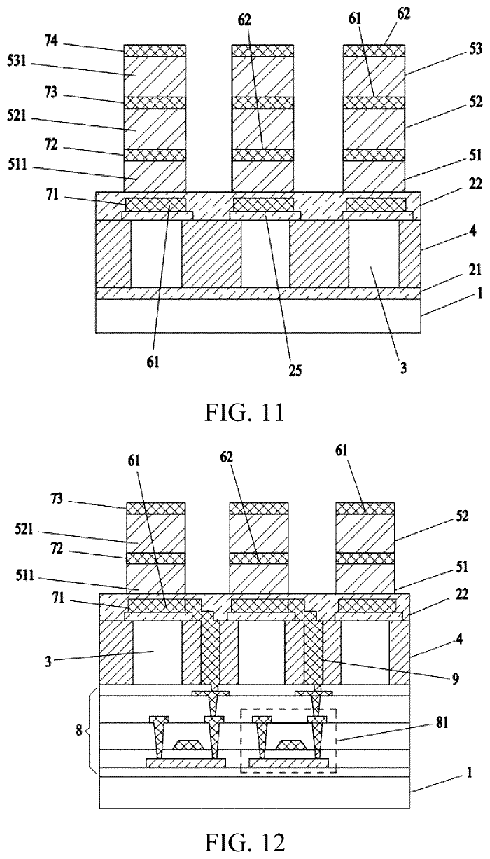

FIG. 11 is a fourth cross-sectional view of an ultrasonic transducer according to an embodiment of the present application. In an exemplary implementation, as shown in FIG. 11, in a direction perpendicular to a plane where an ultrasonic transducer is located, the ultrasonic transducer according to the embodiment of the present application includes a base substrate 1, a first inorganic dielectric layer 21 provided on the base substrate 1, at least one cavity 3 and a support layer 4 provided on the first inorganic dielectric layer 21, an inorganic dielectric pattern 25 provided on the cavity 3 and the support layer 4, a first electrode layer 71 provided on the inorganic dielectric pattern 25, a second inorganic dielectric layer 22 provided on the first electrode layer 71, a first vibration film layer 51 provided on the second inorganic dielectric layer 22, a second electrode layer 72 provided on the first vibration film layer 51, a second vibration film layer 52 provided on the second electrode layer, a third electrode layer 73 provided on the second vibration film layer 52, a third vibration film layer 53 provided on the third electrode layer, and a fourth electrode layer 74 provided on the third vibration film layer 53.

In an exemplary embodiment, as shown in FIG. 11, a first electrode layer 71 may include at least one patterned first electrode 61. A second electrode layer 72 may include at least one patterned second electrode 62. A third electrode layer 73 may include at least one patterned first electrode 61. A fourth electrode layer 74 may include at least one patterned second electrode 62.

In an exemplary implementation, as shown in FIG. 11, a first vibration film layer 51 may include at least one patterned first vibration pattern 511, a second vibration film layer 52 may include at least one patterned second vibration pattern 521, and a third vibration film layer 53 may include at least one patterned third vibration pattern 531. The first vibration pattern 511, the second vibration pattern 521, and the third vibration pattern 531 are all located in a vibration region of an ultrasonic transducer. Orthographic projections of the first vibration pattern 511, the second vibration pattern 521, the third vibration pattern 531, and a cavity 3 on the base substrate 1 overlap. For example, the orthographic projection of the cavity 3 on the base substrate 1 is located in orthographic projections of the first vibration pattern 511, the second vibration pattern 521, and the third vibration pattern 531 on the base substrate 1. A first electrode 61 of the first electrode layer 71 and a second electrode 62 of the second electrode layer 72 are provided on opposite sides of the first vibration pattern 511 in the thickness direction, respectively. An orthographic projection of the first vibration pattern 511 on the base substrate 1 overlaps with orthographic projections of the first electrode 61 of the first electrode layer 71 and the second electrode 62 of the second electrode layer 72 on the base substrate 1. The first vibration pattern 511 can be vibrated by a first excitation voltage supplied by a first electrode 61 of the first electrode layer 71 and a second electrode 62 of the second electrode layer 72. A second electrode 62 of the second electrode layer 72 and a first electrode 61 of the third electrode layer 73 are provided on opposite sides of the second vibration pattern 521 in the thickness direction, respectively. An orthographic projection of the second vibration pattern 521 on the base substrate 1 overlaps with orthographic projections of the second electrode 62 of the second electrode layer 72 and the first electrode 61 of the third electrode layer 73 on the base substrate 1. The second vibration pattern 521 may be vibrated by a second excitation voltage supplied by a second electrode 62 of the second electrode layer 72 and a first electrode 61 of the third electrode layer 73. A first electrode 61 of the third electrode layer 73 and a second electrode 62 of the fourth electrode layer 74 are provided on opposite sides of the third vibration pattern 531 in the thickness direction, respectively. An orthographic projection of the third vibration pattern 531 on the base substrate 1 overlaps with orthographic projections of the first electrode 61 of the third electrode layer 73 and the second electrode 62 of the fourth electrode layer 74 on the base substrate 1. The third vibration pattern 531 may be vibrated by a third excitation voltage supplied by a first electrode 61 of the third electrode layer 73 and a second electrode 62 of the fourth electrode layer 74.

In an exemplary implementation, as shown in FIG. 11, a first vibration film layer 51 may include at least two first vibration patterns 511. The number of the first vibration patterns 511 of the first vibration film layer 51 may be the same as the number of cavities 3. A third hollow region is provided between the at least two first vibration patterns 511. The third hollow region is located in a non-vibration region of the ultrasonic transducer. A plurality of first vibration patterns 511 and third hollow regions may be formed by patterning a first vibration film.

In an exemplary implementation, as shown in FIG. 11, a second vibration film layer 52 may include at least two second vibration patterns 521. The number of second vibration patterns 521 of the second vibration film layer 52 may be the same as the number of cavities 3. A fourth hollow region is provided between the at least two second vibration patterns 521. The fourth hollow region is located in a non-vibration region of the ultrasonic transducer. A plurality of second vibration patterns 521 and fourth hollow regions may be formed by patterning a second vibration film.

In an exemplary implementation, as shown in FIG. 11, a third vibration film layer 53 may include at least two third vibration patterns 531. The number of the third vibration patterns 531 of the third vibration film layer 53 may be the same as the number of cavities 3. A fifth hollow region is provided between the at least two third vibration patterns 531. The fifth hollow region is located in a non-vibration region of the ultrasonic transducer. A plurality of third vibration patterns 531 and fifth hollow regions may be formed by patterning a third vibration film.

The ultrasonic transducer with the above structure in the embodiment of the present application can be used as a fingerprint identification structure and combined with a display substrate to be applied into a display device. For example, the ultrasonic transducer of the embodiment of the present application may be disposed on a light-emitting surface of a display substrate, or the ultrasonic transducer of the embodiment of the present application may be disposed in the display substrate.

The ultrasonic transducers (such as the ultrasonic transducer shown in FIG. 10 or FIG. 11) according to the above embodiments of the present application can be applied as a fingerprint identification structure into a display device.

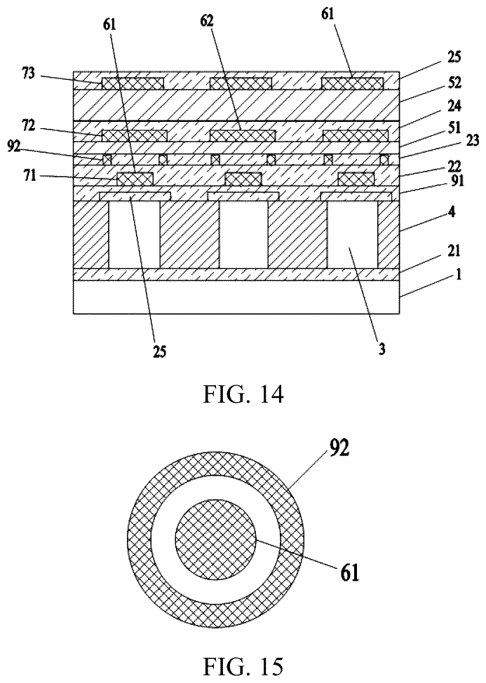

FIG. 14 is a fifth cross-sectional view of an ultrasonic transducer according to an embodiment of the present application. As shown in FIG. 14, in a direction perpendicular to a plane where an ultrasonic transducer is located, the ultrasonic transducer according to the embodiment of the present application includes a base substrate 1, a first inorganic dielectric layer 21 provided on the base substrate 1, at least one cavity 3 and a support layer 4 provided on the first inorganic dielectric layer 21, an inorganic dielectric pattern 25 provided on a side of the cavity 3 and the support layer 4 away from the base substrate 1, a flexible dielectric layer 91 provided on a side of the inorganic dielectric pattern 25 away from the base substrate 1, a first electrode layer 71 provided on a side of the flexible dielectric layer 91 away from the base substrate 1, a second inorganic dielectric layer 22 provided on the first electrode layer 71, a first additional electrode 92 provided on the second inorganic dielectric layer 22, a third inorganic dielectric layer 23 provided on the first additional electrode 92, a first vibration film layer 51 provided on the third inorganic dielectric layer 23, a second electrode layer 72 provided on the first vibration film layer 51, a fourth inorganic dielectric layer 24 provided on the second electrode layer 72, a second vibration film layer 52 provided on the fourth inorganic dielectric layer 24, a third electrode layer 73 provided on the second vibration film layer 52, and a fifth inorganic dielectric layer 25 provided on the third electrode layer 73. A material of the flexible dielectric layer 91 may be polyimide (PI).

In an exemplary embodiment, as shown in FIG. 14, a first electrode layer 71 may include at least one patterned first electrode 61, a second electrode layer 72 may include at least one patterned second electrode 62, and a third electrode layer 73 may include at least one patterned first electrode 61. Orthographic projections of a cavity 3, a first electrode 61 of the first electrode layer 71, a first vibration film layer 51, a second electrode 62 of the second electrode layer 72, a second vibration film layer 52, and a first electrode 61 of the third electrode layer 73 on the base substrate 1 overlap.

In an exemplary implementation, as shown in FIG. 14, a first additional electrode 92 is located on a side of the first vibration film layer 51 away from a second electrode 62 of a second electrode layer 72. The first additional electrode 92 is located on a different film layer from a first electrode 61 of the first electrode layer 71. The first additional electrode 92 is located between the first electrode layer 71 and the second electrode layer 72. In some embodiments, the first additional electrode may be located in the first electrode layer and in the same film layer as a first electrode of the first electrode layer.

In an exemplary implementation, as shown in FIG. 14, an orthographic projection of a first additional electrode 92 on the base substrate 1 does not overlap with an orthographic projection of a first electrode 61 of the first electrode layer 71 on the base substrate 1, and the first additional electrode 92 and the first electrode 61 of the first electrode layer 71 are insulated from each other. An orthographic projection of a first additional electrode 92 on the base substrate 1 overlaps with an orthographic projection of the first vibration film layer 51 on the base substrate 1 and an orthographic projection of a second electrode 62 of the second electrode layer 72 on the base substrate 1. A vibration direction of the first vibration film layer 51 between the first additional electrode 92 and the second electrode 62 of the second electrode layer 72 is opposite to a vibration direction of the first vibration film layer 51 between the first electrode 61 of the first electrode layer 71 and the second electrode 62 of the second electrode layer 72.

An ultrasonic transducer according to an embodiment of the present application can control the voltages of a first additional electrode 92 and a second electrode 62 of the second electrode layer 72, and the voltages of a first electrode 61 of the first electrode layer 71 and the second electrode 62 of the second electrode layer 72, so that a vibration direction of the first vibration film layer 51 between the first additional electrode 92 and the second electrode 62 of the second electrode layer 72 is opposite to a vibration direction of the first vibration film layer 51 between the first electrode 61 of the first electrode layer 71 and the second electrode 62 of the second electrode layer 72. Thus a tension of the first vibration film layer 51 is increased, thereby increasing a vibration displacement of the first vibration film layer 51 and further increasing a sound pressure of a device.

FIG. 15 is a top view of a first additional electrode and a first electrode of an ultrasonic transducer according to an embodiment of the present application. As shown in FIG. 15, in a direction parallel to a plane where the ultrasonic transducer is located, an orthographic projection of a first additional electrode 92 on the base substrate may be annular. For example, an orthographic projection of a first additional electrode 92 on the base substrate may be circularly annular or elliptically annular. An orthographic projection of a first electrode 61 of the first electrode layer 71 on the base substrate may be circular or elliptical. An orthographic projection of a first additional electrode 92 on the base substrate surrounds an outer side of an orthographic projection of a first electrode 61 of the first electrode layer 71 on the base substrate.

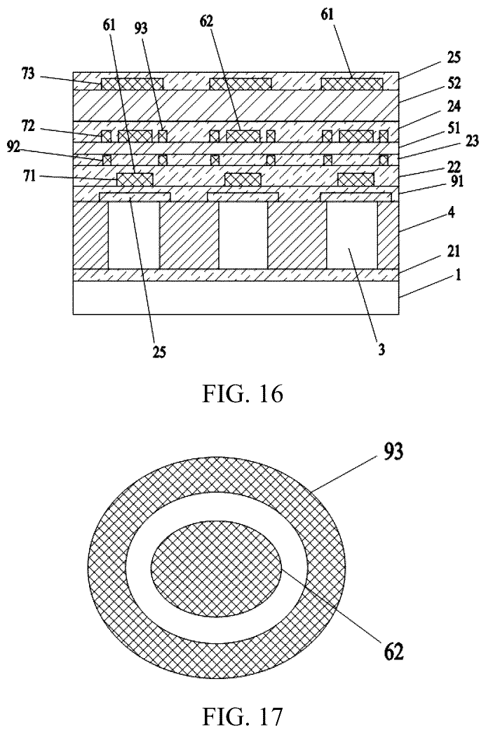

FIG. 16 is a sixth cross-sectional view of an ultrasonic transducer according to an embodiment of the present application. As shown in FIG. 16, in a direction perpendicular to a plane where an ultrasonic transducer is located, the ultrasonic transducer according to the embodiment of the present application includes a base substrate 1, a first inorganic dielectric layer 21 provided on the base substrate 1, at least one cavity 3 and a support layer 4 provided on the first inorganic dielectric layer 21, an inorganic dielectric pattern 25 provided on a side of the cavity 3 and the support layer 4 away from the base substrate 1, a flexible dielectric layer 91 provided on a side of the inorganic dielectric pattern 25 away from the base substrate 1, a first electrode layer 71 provided on a side of the flexible dielectric layer 91 away from the base substrate 1, a second inorganic dielectric layer 22 provided on the first electrode layer 71, a first additional electrode 92 provided on the second inorganic dielectric layer 22, a third inorganic dielectric layer 23 provided on the first additional electrode 92, a first vibration film layer 51 provided on the third inorganic dielectric layer 23, a second electrode layer 72 provided on the first vibration film layer 51, a fourth inorganic dielectric layer 24 provided on the second electrode layer 72, a second vibration film layer 52 provided on the fourth inorganic dielectric layer 24, a third electrode layer 73 provided on the second vibration film layer 52, and a fifth inorganic dielectric layer 25 provided on the third electrode layer 73. A material of the flexible dielectric layer 91 may be polyimide (PI).

In an exemplary embodiment, as shown in FIG. 16, a first electrode layer 71 may include at least one patterned first electrode 61, a second electrode layer 72 may include at least one patterned second electrode 62 and at least one second additional electrode 93, and a third electrode layer 73 may include at least one patterned first electrode 61. Orthographic projections of a cavity 3, a first electrode 61 of the first electrode layer 71, a first vibration film layer 51, a second electrode 62 of the second electrode layer 72, a second vibration film layer 52, and a first electrode 61 of the third electrode layer 73 on the base substrate 1 overlap.

In an exemplary implementation, as shown in FIG. 16, a first additional electrode 92 is located on a side of the first vibration film layer 51 away from a second electrode 62 of a second electrode layer 72. The first additional electrode 92 is located on a different film layer from a first electrode 61 of the first electrode layer 71. The first additional electrode 92 is located between the first electrode layer 71 and the second electrode layer 72. An orthographic projection of the first additional electrode 92 on the base substrate 1 does not overlap with an orthographic projection of the first electrode 61 of the first electrode layer 71 on the base substrate 1, and the first additional electrode 92 and the first electrode 61 of the first electrode layer 71 are insulated from each other. An orthographic projection of the first additional electrode 92 on the base substrate 1 does not overlap with an orthographic projection of the second electrode 62 of the second electrode layer 72 on the base substrate 1. In some embodiments, the first additional electrode may be located in the first electrode layer and in the same film layer as a first electrode of the first electrode layer.

In an exemplary implementation, as shown in FIG. 16, a second additional electrode 93 is located on a side of the first vibration film layer 51 away from the first electrode 61 of the first electrode layer 71, and the second additional electrode 93 is located in the same film layer as a second electrode 62 of the second electrode layer 72. An orthographic projection of the second additional electrode 93 on the base substrate 1 does not overlap with an orthographic projection of the second electrode 62 of the second electrode layer 72 on the base substrate 1, and the second additional electrode 93 and the second electrode 62 of the second electrode layer 72 are insulated from each other. An orthographic projection of the second additional electrode 93 on the base substrate 1 does not overlap with an orthographic projection of the first electrode 61 of the first electrode layer 71 on the base substrate 1. In some embodiments, the first additional electrode may be located in a different film layer from the second electrode of the second electrode layer.

In an exemplary implementation, as shown in FIG. 16, an orthographic projection of a first additional electrode 92 on the base substrate 1 overlaps with an orthographic projection of a second additional electrode 93 on the base substrate 1, and both an orthographic projection of a first additional electrode 92 on the base substrate and an orthographic projection of a second additional electrode 93 on the base substrate overlap with an orthographic projection of a first vibration film layer 51 on the base substrate. A vibration direction of the first vibration film layer 51 between the first additional electrode 92 and the second additional electrode 93 is opposite to a vibration direction of the first vibration film layer 51 between a first electrode 61 of a first electrode layer 71 and a second electrode 62 of a second electrode layer 72.

An ultrasonic transducer according to an embodiment of the present application can control a voltage of a first additional electrode 92 and a second additional electrode 93, and a voltage of a first electrode 61 of a first electrode layer 71 and a second electrode 62 of a second electrode layer 72, so that a vibration direction of a first vibration film layer 51 between the first additional electrode 92 and the second additional electrode 93 is opposite to a vibration direction of the first vibration film layer 51 between the first electrode 61 of the first electrode layer 71 and the second electrode 62 of the second electrode layer 72. Thus a tension of the first vibration film layer 51 is increased, thereby increasing a vibration displacement of the first vibration film layer 51 and further increasing the sound pressure of a device.

FIG. 17 is a top view of a second additional electrode and a second electrode of an ultrasonic transducer according to an embodiment of the present application. As shown in FIG. 17, in a direction parallel to a plane where the ultrasonic transducer is located, an orthographic projection of a second additional electrode 93 on the base substrate may be annular. For example, an orthographic projection of the second additional electrode 93 on the base substrate may be circularly annular or elliptically annular. An orthographic projection of a second electrode 62 of a second electrode layer 72 on the base substrate may be circular or elliptical. An orthographic projection of a second additional electrode 93 on the base substrate surrounds an outer side of an orthographic projection of a second electrode 62 of the second electrode layer 72 on the base substrate.

FIG. 12 is a cross-sectional view of a fingerprint identification structure according to an embodiment of the present application. In an exemplary implementation, as shown in FIG. 12, the embodiment of the present application also provides a fingerprint identification structure including the ultrasonic transducer as described above (e.g. an ultrasonic transducer as shown in FIG. 10) and a circuit layer 8 disposed between a base substrate 1 and a cavity 3. The circuit layer 8 includes at least one transistor 81, which may include an active layer, a gate, a source electrode, a drain electrode and the like. The drain electrode or the source electrode of the at least one transistor 81 is electrically connected to a first electrode 61 of the ultrasonic transducer. The circuit layer 8 is configured to provide a driving signal to the ultrasonic transducer to vibrate a vibration film layer of the ultrasonic transducer to emit an ultrasonic signal and to receive a fingerprint identification signal fed back by the ultrasonic transducer.

In an exemplary implementation, as shown in FIG. 12, a fingerprint identification structure according to an embodiment of the present application further includes a connection electrode 9. A portion of the connection electrode 9 is disposed in the same layer as a cavity 3 and a support layer 4, and an orthographic projection of the portion of the connection electrode 9 on the base substrate does not overlap with an orthographic projection of the cavity 3 on the base substrate. One end of the connection electrode 9 penetrates through the support layer 4 and is electrically connected with a first electrode 61 of the first electrode layer 71, and the other end of the connection electrode 9 penetrates through the support layer 4 and is electrically connected with a transistor 81 of a circuit layer 8, thereby realizing the electrical connection between the ultrasonic transducer and the circuit layer 8.

In an ultrasonic wave emission stage, a vibration pattern in each vibration film layer (e.g. a first vibration pattern 511 and a second vibration pattern 521) is vibrated by an excitation voltage supplied by a first electrode and a second electrode, respectively, to emit ultrasonic wave signals emitted in a direction away from the base substrate 1. The ultrasonic wave signals reach valleys and ridges of human fingers, and after being reflected by the valleys and ridges of fingers, the ultrasonic wave signals reach the vibration pattern in the vibration film layer again, and an acoustic-electrical signal transformation is performed. The electric signal transformed from the ultrasonic wave signals is transmitted to the circuit layer 8, and is processed and imaged by the circuit layer 8, thereby realizing fingerprint identification. The fingerprint identification structure described above can reduce crosstalk of reflected ultrasonic signals and improve imaging quality and clarity.

An embodiment of the present application also provides a preparation method for the ultrasonic transducer described above, including: forming a cavity on a base substrate and forming a first electrode on the cavity; and forming at least two vibration film layers, a first electrode and a second electrode on the first electrode.

The at least two vibration film layers are stacked in a thickness direction of the base substrate, and an orthographic projection of the at least two vibration film layers on the base substrate overlaps with an orthographic projection of the cavity on the base substrate. The first electrode and the second electrode are respectively located on opposite sides of each of the at least two vibration film layers in the thickness direction. The first electrode or the second electrode is provided on a surface of the at least two vibration film layers away from the base substrate.

In an exemplary implementation, the base substrate includes a cavity region and a non-cavity region. Forming a cavity on a base substrate and forming a first electrode on the cavity includes: forming a metal film covering the cavity region and the non-cavity region on the base substrate; etching and removing a portion of the metal film on the non-cavity region, and retaining the metal film on the cavity region and a portion of the metal film on the non-cavity region; forming a support layer on the non-cavity region where the metal film is removed; forming a first electrode on the support layer and the metal film on the cavity region, an orthographic projection of the first electrode on the base substrate overlapping with an orthographic projection of the metal film on the cavity region on the base substrate; and by an etching process, removing a portion of the metal film on the non-cavity region to form an etching hole, and removing the metal film on the cavity region to form a cavity, the etching hole communicating with the cavity.

In an exemplary implementation, forming a first electrode on the support layer and the metal film on the cavity region includes: sequentially depositing an inorganic film and a first electrode film on the support layer and the cavity region; and by a patterning process, forming the inorganic film into an inorganic dielectric pattern, and forming the first electrode film into a first electrode disposed on the inorganic dielectric pattern. Both an orthographic projection of the first electrode on the base substrate and an orthographic projection of the inorganic dielectric pattern on the base substrate do not overlap with an orthographic projection of the etching hole on the base substrate.

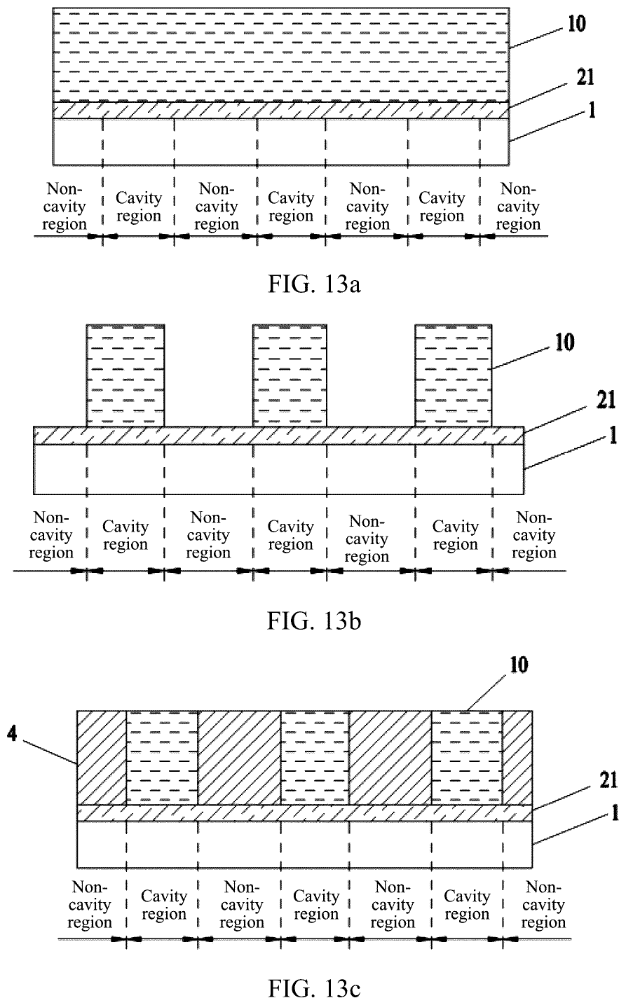

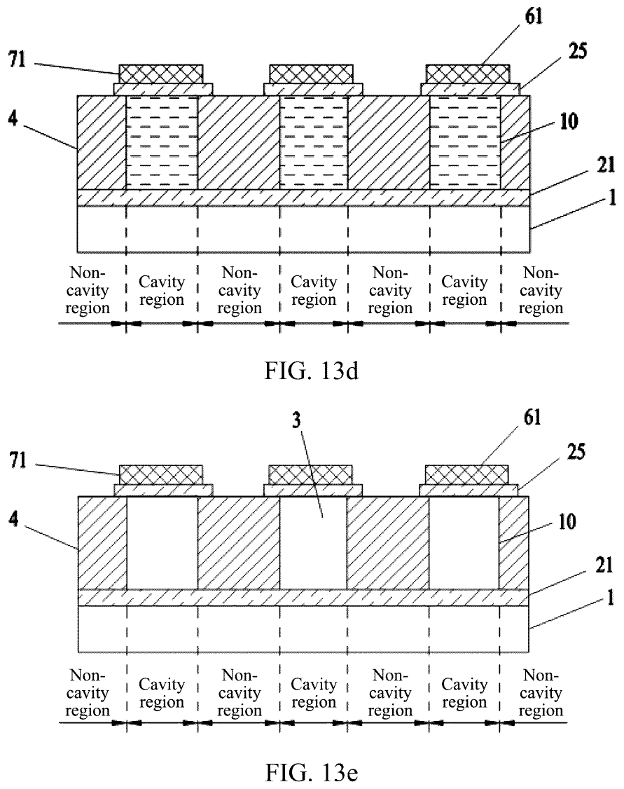

FIGS. 13a to 13e are schematic diagrams of a preparation process of an ultrasonic transducer according to an embodiment of the present application. A preparation method for a ultrasonic transducer according to an embodiment of the present application includes the following steps.

(1) Providing a base substrate 1, the base substrate 1 including a cavity region and a non-cavity region.

In an exemplary embodiment, a material of the base substrate 1 may include a rigid material or a flexible material. For example, the rigid material may include glass, and the flexible material may include a flexible light-transmitting resin.

(2) Forming a cavity and a first electrode layer on the base substrate. Forming a cavity and a first electrode layer on the base substrate 1 includes the following steps.

First, forming a first inorganic dielectric layer 21 on the base substrate 1.

Thereafter, depositing a metal film 10 having a certain thickness on the first inorganic dielectric layer 21 by an electroplating process, the metal film 10 covering a cavity region and a non-cavity region, as shown in FIG. 13a. The metal film 10 may include a metal such as copper, aluminum.

Thereafter, by an etching process, etching and removing a portion of the metal film 10 on the non-cavity region, and retaining a portion of the metal film 10 on the non-cavity region and the metal film 10 on the cavity region as shown in FIG. 13b. A retained portion of the metal film 10 on the non-cavity region may be used to form an etching hole and an etching flow channel.

Thereafter, depositing an organic film on the non-cavity region where the metal film 10 is removed, and forming the organic film into a support layer 4 by a patterning process. The support layer 4 is provided in the same layer as the metal film 10 and around a periphery of the metal film 10, and a thickness of the support layer 4 may be the same as that of the metal film 10, as shown in FIG. 13c.

Thereafter, depositing an inorganic film and a first electrode film on the support layer 4 and the metal film 10 on the cavity region, and by a patterning process, forming the inorganic film into a fifth inorganic dielectric layer including an inorganic dielectric pattern 25, and forming the first electrode film into a first electrode 61 provided on the inorganic dielectric pattern 25. An edge region of the inorganic dielectric pattern 25 is provided on the support layer 4. An orthographic projection of a middle region of the inorganic dielectric pattern 25 on the base substrate overlaps with an orthographic projection of the metal film 10 on the cavity region on the base substrate. The inorganic dielectric pattern 25 may ensure that the film layer (e.g. the first electrode) on the inorganic dielectric pattern 25 does not collapse during the formation of the cavity 3. An orthographic projection of the first electrode 61 on the base substrate overlaps with either of orthographic projections of the inorganic dielectric pattern 25 and the metal film 10 on the cavity region on the base substrate, as shown in FIG. 13d. Either of the orthographic projections of the inorganic dielectric pattern 25 and the first electrode 61 on the base substrate does not overlap with an orthographic projection of a portion of the metal film 10 on the non-cavity region on the base substrate.

Thereafter, removing a portion of the metal film 10 on the non-cavity region to form an etching hole and an etching flow channel by an etching process, and then etching and removing the metal film 10 on the cavity region to form a cavity 3 by passing an etching liquid through the etching hole and the etching flow channel, as shown in FIG. 13e. An orthographic projection of the cavity 3 on the base substrate overlaps with orthographic projections of the inorganic dielectric pattern 25 and the first electrode 61 on the base substrate.

(3) Forming a second inorganic dielectric layer 22 on the first electrode layer, forming a first vibration film layer 51 on the second inorganic dielectric layer 22, forming a second electrode layer 72 on the first vibration film layer 51, forming a third inorganic dielectric layer 23 on the second electrode layer 72, forming a second vibration film layer 52 on the third inorganic dielectric layer 23, forming a third electrode layer 73 on the second vibration film layer 52, and forming a fourth inorganic dielectric layer 24 on the third electrode layer 73, as shown in FIG. 3. The second electrode layer 72 may include at least one patterned second electrode 62, and the third electrode layer 73 may include at least one patterned first electrode 61. Both the first vibration film layer 51 and the second vibration film layer 52 may be located in a vibration region and a non-vibration region of the base substrate. Both the first vibration film layer 51 and the second vibration film layer 52 may be disposed over the entire surface without patterning. Both the first vibration film layer 51 and the second vibration film layer 52 may cover at least two cavities 3.

The present application also provides a display device including the fingerprint identification structure or the sound-producing structure as described in any of the foregoing exemplary embodiments. The display device may be any product or component with a display function, such as a mobile phone, a tablet computer, a television, a display, a laptop computer, a digital photo frame, or a navigator.

The drawings of the present disclosure only involve structures involved in the present disclosure, and other structures may refer to conventional designs. The embodiments of the present disclosure, i.e., features in the embodiments, may be combined with each other to obtain new embodiments if there is no conflict.

Those of ordinary skills in the art should understand that modifications or equivalent replacements may be made to the technical solutions of the present disclosure without departing from the essence and scope of the technical solutions of the present disclosure, and shall all fall within the scope of the claims of the present disclosure.

1. An ultrasonic transducer comprising:
a base substrate;
a cavity located on the base substrate;
at least two vibration film layers located on the base substrate, wherein the at least two vibration film layers are stacked in a thickness direction of the base substrate, the at least two vibration film layers are each located on a side of the cavity away from the base substrate, and orthographic projections of the at least two vibration film layers on the base substrate overlap with an orthographic projection of the cavity on the base substrate; and
a first electrode and a second electrode respectively located on opposite sides of each vibration film layer in the thickness direction;
wherein the first electrode or the second electrode is provided on a side of the at least two vibration film layers away from the base substrate.

2. The ultrasonic transducer according to claim 1, wherein the first electrode is provided on a side of the at least two vibration film layers close to the cavity; or
wherein orthographic projections of the at least two vibration film layers on the base substrate each overlap with orthographic projections of at least two cavities on the base substrate;
wherein the ultrasonic transducer comprises a first vibration film layer and a second vibration film layer sequentially stacked in a direction away from the base substrate, wherein a first electrode layer is provided on a side of the first vibration film layer close to the cavity, the first electrode layer comprises a first electrode, a second electrode layer is provided between the first vibration film layer and the second vibration film layer, the second electrode layer comprises a second electrode, a third electrode layer is provided on a surface of the second vibration film layer away from the base substrate, and the third electrode layer comprises a first electrode; and
wherein the second electrode of the second electrode layer serves as an electrode of the first vibration film layer and an electrode of the second vibration film layer.

3-5. (canceled)

6. The ultrasonic transducer according to claim 32, comprising a first vibration film layer, a second vibration film layer, and a third vibration film layer sequentially stacked in a direction away from the base substrate, wherein a first electrode layer is provided on a side of the first vibration film layer close to the cavity, the first electrode layer comprises a first electrode, a second electrode layer is provided between the first vibration film layer and the second vibration film layer, the second electrode layer comprises a second electrode, a third electrode layer is provided between the second vibration film layer and the third vibration film layer, the third electrode layer comprises a first electrode, a fourth electrode layer is provided on a surface of the third vibration film layer away from the base substrate, and the fourth electrode layer comprises a second electrode; and
wherein the second electrode of the second electrode layer serves as an electrode of the first vibration film layer and an electrode of the second vibration film layer, and the first electrode of the third electrode layer serves as an electrode of the second vibration film layer and an electrode of the third vibration film layer.

7. (canceled)

8. The ultrasonic transducer according to claim 1, wherein the at least two vibration film layers each comprise a vibration pattern, and an orthographic projection of the vibration pattern on the base substrate overlaps with an orthographic projection of one cavity on the base substrate;
wherein the ultrasonic transducer comprises a first vibration film layer and a second vibration film layer sequentially stacked in a direction away from the base substrate, wherein the first vibration film layer comprises at least one first vibration pattern, the second vibration film layer comprises at least one second vibration pattern, and orthographic projections of the first vibration pattern, the second vibration pattern and the cavity on the base substrate overlap; and
wherein a first electrode is provided on a side of the first vibration pattern close to the cavity, a second electrode is provided between the first vibration pattern and the second vibration pattern, a first electrode is provided on a surface of the second vibration pattern away from the base substrate, and orthographic projections of the first vibration pattern, the second vibration pattern, the first electrode and the second electrode on the base substrate overlap.

9-10. (canceled)

11. The ultrasonic transducer according to claim 8, comprising a first vibration film layer, a second vibration film layer, and a third vibration film layer sequentially stacked in a direction away from the base substrate, wherein the first vibration film layer comprises a first vibration pattern, the second vibration film layer comprises a second vibration pattern, the third vibration film layer comprises a third vibration pattern, and orthographic projections of the first vibration pattern, the second vibration pattern, the third vibration pattern and the cavity on the base substrate overlap; and
wherein a first electrode is provided on a side of the first vibration pattern close to the cavity, a second electrode is provided between the first vibration pattern and the second vibration pattern, a first electrode is provided between the second vibration pattern and the third vibration pattern, a second electrode is provided on a surface of the third vibration pattern away from the base substrate, and orthographic projections of the first vibration pattern, the second vibration pattern, the third vibration pattern, the first electrode and the second electrode on the base substrate overlap.

12. (canceled)

13. The ultrasonic transducer according to claim 1, wherein a material of the vibration film layer comprises a polymer material; or
wherein the ultrasonic transducer further comprises an etching hole disposed in the same layer as the cavity and communicated with the cavity;
wherein the ultrasonic transducer further comprises an etching flow channel, wherein the etching flow channel is disposed in the same layer as the cavity, one end of the etching flow channel is communicated with the etching hole, and the other end of the etching flow channel is communicated with the cavity;
wherein one etching hole is communicated with one cavity; or
wherein a plurality of etching holes are communicated with one cavity; and
wherein two etching holes are located on opposite sides of one cavity, and the two etching holes are communicated with one cavity.

14-18. (canceled)

19. The ultrasonic transducer according to claim 13, wherein one etching hole is communicated with a plurality of cavities;
wherein at least three cavities are arranged at intervals to form a column of cavities, two etching holes are located on a side of the column of cavities, the two etching holes are communicated with each other by a second etching flow channel, the two etching holes are respectively communicated with cavities at both ends of the column of cavities by first etching flow channels, and other cavities in the column of cavities are communicated with the second etching flow channel by first etching flow channels; or
wherein four cavities of the cavities are arranged in a rectangular manner, the four cavities are disposed around a perimeter of one etching hole, and the four cavities are all communicated with the one etching hole.

20-21. (canceled)

22. The ultrasonic transducer according to claim 13, wherein the first electrode is provided on a side of the at least two vibration film layers close to the cavity, and an orthographic projection of the etching hole on the base substrate does not overlap with an orthographic projection of the first electrode on the base substrate.

23. The ultrasonic transducer according to claim 1, comprising at least two cavities, wherein a distance between geometric centers of adjacent cavities is the same; or
wherein the ultrasonic transducer further comprises a support layer disposed in the same layer as the cavity;
wherein the support layer comprises an organic material; or
wherein the ultrasonic transducer further comprises an inorganic dielectric pattern, wherein the first electrode is disposed on a side of the at least two vibration film layers close to the cavity, the inorganic dielectric pattern is positioned between the support layer and the first electrode, an edge region of the inorganic dielectric pattern is disposed on the support layer, an orthographic projection of a middle region of the inorganic dielectric pattern on the base substrate overlaps with an orthographic projection of the cavity on the base substrate, and the first electrode is disposed on a surface of the inorganic dielectric pattern away from the cavity; and
wherein the ultrasonic transducer further comprises an etching hole, wherein the etching hole is disposed in the same layer as the cavity and communicated with the cavity, and an orthographic projection of the inorganic dielectric pattern on the base substrate does not overlap with an orthographic projection of the etching hole on the base substrate.

24-27. (canceled)

28. The ultrasonic transducer according to claim 1, comprising at least two first electrodes and a first wire disposed in the same layer, wherein the at least two first electrodes are arranged at intervals in a first direction to form a row of first electrodes, the first wire extends in the first direction, and adjacent first electrodes in the row of first electrodes are electrically connected to each other by the first wire;
wherein the ultrasonic transducer further comprises at least two second electrodes and a second wire disposed in the same layer, wherein the at least two second electrodes are arranged at intervals in a second direction to form a column of second electrodes, the second wire extends in the second direction, adjacent second electrodes in the column of second electrodes are electrically connected to each other by the second wire, orthographic projections of the first wire and the second wire on the base substrate do not overlap, and the first direction crosses the second direction.

29. (canceled)

30. The ultrasonic transducer according to claim 1, wherein orthographic projections of the first electrode and the second electrode on the base substrate both cover an orthographic projection of the cavity on the base substrate; and
wherein diameters of orthographic projections of the first electrode and the second electrode on the base substrate are both 1.2 to 2 times a diameter of an orthographic projection of the cavity on the base substrate.

31. (canceled)

32. The ultrasonic transducer according to claim 1, further comprising a first additional electrode located on a side of a vibration film layer away from the second electrode, wherein the first additional electrode and the first electrode are located on the same film layer, or the first additional electrode and the first electrode are located on different film layers, orthographic projections of the first additional electrode and the first electrode on the base substrate do not overlap and the first additional electrode and the first electrode are insulated from each other, an orthographic projection of the first additional electrode on the base substrate overlaps with either of orthographic projections of the vibration film layer and the second electrode on the base substrate, and a vibration direction of a vibration film layer between the first additional electrode and the second electrode is opposite to a vibration direction of a vibration film layer between the first electrode and the second electrode; or
wherein the ultrasonic transducer further comprises a first additional electrode and a second additional electrode, wherein the first additional electrode is located on a side of a vibration film layer away from the second electrode, the first additional electrode and the first electrode are located in the same film layer or the first additional electrode and the first electrode are located in different film layers, an orthographic projection of the first additional electrode on the base substrate does not overlap with an orthographic projection of the first electrode on the base substrate and the first additional electrode and the first electrode are insulated from each other, the second additional electrode is located on a side of the vibration film layer away from the first electrode, the second additional electrode and the second electrode are located in the same film layer or the second additional electrode and the second electrode are located in different film layers, an orthographic projection of the second additional electrode on the base substrate does not overlap with an orthographic projection of the second electrode on the base substrate and the second additional electrode and the second electrode are insulated from each other, orthographic projections of the first additional electrode and the second additional electrode on the base substrate overlap and the orthographic projections of the first additional electrode and the second additional electrode on the base substrate overlap with an orthographic projection of the vibration film layer on the base substrate, and a vibration direction of a vibration film layer between the first additional electrode and the second additional electrode is opposite to a vibration direction of a vibration film layer between the first electrode and the second electrode;
wherein the orthographic projection of the first additional electrode on the base substrate is annular, and the orthographic projection of the first additional electrode on the base substrate surrounds an outer side of the orthographic projection of the first electrode on the base substrate; and
wherein the orthographic projection of the first additional electrode on the base substrate is annular, and the orthographic projection of the first additional electrode on the base substrate surrounds an outer side of the orthographic projection of the first electrode on the base substrate; and/or, the orthographic projection of the second additional electrode on the base substrate is annular, and the orthographic projection of the second additional electrode on the base substrate surrounds an outer side of the orthographic projection of the second electrode on the base substrate.

33-35. (canceled)

36. The ultrasonic transducer according to claim 1, wherein a depth of the cavity is 5 microns to 20 microns.

37. A fingerprint identification structure comprising the ultrasonic transducer according to claim 1 and a circuit layer disposed between the base substrate and the cavity of the ultrasonic transducer, wherein the circuit layer comprises at least one transistor electrically connected to a first electrode of the ultrasonic transducer.

38. The fingerprint identification structure according to claim 37, further comprising a connection electrode, wherein at least a portion of the connection electrode is disposed in the same layer as the cavity, one end of the connection electrode is electrically connected to a first electrode of the ultrasonic transducer, and the other end of the connection electrode is electrically connected to the transistor of the circuit layer.

39. A sound-producing structure comprising the ultrasonic transducer according to claim 1.

40. A display device comprising a fingerprint identification structure or a sound-producing structure,
wherein the fingerprint identification structure comprises the ultrasonic transducer according to claim 1 and a circuit layer disposed between the base substrate and the cavity of the ultrasonic transducer, wherein the circuit layer comprises at least one transistor electrically connected to a first electrode of the ultrasonic transducer; and
wherein the sound-producing structure comprises the ultrasonic transducer.

41. The display device according to claim 40, wherein the base substrate of the ultrasonic transducer comprises a display region and a bonding region located on at least one side of the display region, the display region is covered by a vibration film layer of the ultrasonic transducer, and an orthographic projection of the vibration film layer of the ultrasonic transducer on the base substrate does not overlap with the bonding region.

42. A preparation method for an ultrasonic transducer comprising:
forming a cavity on a base substrate and forming a first electrode on the cavity; and
forming at least two vibration film layers, a first electrode and a second electrode on the first electrode;
wherein the at least two vibration film layers are stacked in a thickness direction of the base substrate, orthographic projections of the at least two vibration film layers on the base substrate overlap with an orthographic projection of the cavity on the base substrate, the first electrode and the second electrode are respectively located on opposite sides of each vibration film layer in the thickness direction, and the first electrode or the second electrode is provided on a side of the at least two vibration film layers away from the base substrate.

43. The preparation method for an ultrasonic transducer according to claim 42, wherein the base substrate comprises a cavity region and a non-cavity region; forming a cavity on a base substrate and forming a first electrode on the cavity comprises:
forming a metal film covering the cavity region and the non-cavity region on the base substrate;
etching and removing a portion of the metal film on the non-cavity region, and retaining the metal film on the cavity region and a portion of the metal film on the non-cavity region;
forming a support layer on the non-cavity region where the metal film is removed;
forming a first electrode on the support layer and the metal film on the cavity region, an orthographic projection of the first electrode on the base substrate overlapping with an orthographic projection of the metal film on the cavity region on the base substrate; and
by an etching process, removing a portion of the metal film on the non-cavity region to form an etching hole, and removing the metal film on the cavity region to form a cavity, the etching hole being communicated with the cavity; and
wherein forming a first electrode on the support layer and the metal film on the cavity region comprises:
sequentially depositing an inorganic film and a first electrode film on the support layer and the cavity region; and
by a patterning process, forming the inorganic film into an inorganic dielectric pattern, and forming the first electrode film into a first electrode disposed on the inorganic dielectric pattern, wherein both an orthographic projection of the first electrode on the base substrate and an orthographic projection of the inorganic dielectric pattern on the base substrate do not overlap with an orthographic projection of the etching hole on the base substrate.

44. (canceled)
